(19) United States
(12) Patent Application Publication
(10) Pub. No.: US 2012/0009407 A1
(43) Pub. Date: Jan. 12, 2012

(54) RIGID POLYURETHANE FOAM

(76) Inventors: Calvin T. Peeler, Canton, MI (US); Todd Wishneski, Missouri City, TX (US); Greg P. Gardin, Cambridge (CA)

(21) Appl. No.: 13/178,926

(22) Filed: Jul. 8, 2011

Related U.S. Application Data
(60) Provisional application No. 61/362,549, filed on Jul. 8, 2010.

(51) Int. Cl. C08G 18/54; B32B 27/40; C08J 9/14

(52) U.S. Cl. 428/220; 521/136; 521/98; 521/97

(57) ABSTRACT

A rigid polyurethane foam includes the reaction product of a resin composition and an isocyanate composition. The resin composition includes a novolac polyol that has a general chemical structure:

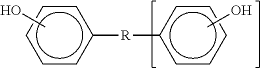

In this structure, R is an alkyl or alkylene group and the novolac polyol has an average hydroxyl functionality of from 2 to 30 calculated by dividing the weight average molecular weight of the novolac polyol by the equivalent weight of the novolac polyol. The novolac polyol is present in an amount of from 3 to 65 parts by weight per 100 parts by weight of the resin composition.

### CROSS-REFERENCE TO RELATED APPLICATIONS

The subject patent application claims priority to, and all the benefits of, U.S. Provisional Patent Application Ser. No. 61/362,549, which was filed on Jul. 8, 2010. The entirety of this provisional patent applications is expressly incorporated herein by reference.

### FIELD OF THE INVENTION

The subject invention generally relates to a rigid polyurethane foam including the reaction product of an isocyanate composition and a resin composition. More specifically, the resin composition includes a particular novolac polyol present in specific amounts.

### DESCRIPTION OF THE RELATED ART

There is an increasing demand for better performing rigid polyurethane foams that have particular flammability specifications and acceptable physical properties. It is well known in the art that when typical rigid polyurethane foams, particularly spray foams, are formed in thicknesses of greater than about 2 inches, such foams are subject to internal scorching due to high exotherm temperatures resulting from reactions of certain isocyanates and polyols. Internal scorching not only degrades the physical properties of the rigid polyurethane foams rendering them unsuitable for most applications but also has the potential to cause other problems related to flammability. In addition, these typical rigid polyurethane foams are flammable and vulnerable to burning and smoking, all of which are undesirable.

To reduce scorch, decrease flammability, and decrease smoking, many rigid polyurethane foams include high levels of halogenated flame retardants. In fact, the California home furnishing flammability requirement, known in the art as Technical Bulletin 117 (TB 117), has led to the annual use of millions of pounds of halogenated fire retardants in California since the early 1980's. Typical halogenated flame retardants are classified as halocarbons and tend to include organochlorines such as PCBs, organobromines such as PBDEs, and halogenated phosphorous compounds such as tri-o-cresyl phosphate, TRIS, TEPA, and others. Although halogenated flame retardants are inexpensive and are most often used to meet the California requirement, they have been linked to environmental concerns. Accordingly, there remains an opportunity to develop a rigid polyurethane foam that has a minimum amount of halogenated flame retardants, that resists scorching, burning, and smoking, and that simultaneously has acceptable physical properties.

### SUMMARY OF THE INVENTION AND ADVANTAGES

The instant invention provides a rigid polyurethane foam that includes the reaction product of a resin composition and an isocyanate composition. The resin composition includes a novolac polyol that has a general chemical structure:

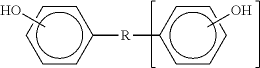

wherein R is an alkyl or alkylene group and the novolac polyol has an average hydroxyl functionality of from 2 to 30 calculated by dividing the weight average molecular weight of the novolac polyol by the equivalent weight of the novolac polyol. The novolac polyol is present in an amount of from 3 to 65 parts by weight per 100 parts by weight of the resin composition. This invention also provides the resin composition itself.

The novolac polyol in the resin composition promotes intumescence (i.e., swelling) of the rigid polyurethane foam, promotes char, decreases scorch, and decreases flammability of the foam. The novolac polyol also acts as an antioxidant and allows for thick section of rigid polyurethane foams to be produced with minimized scorch. The novolac polyol is also thought to react with isocyanates more quickly than the isocyanates react with water thereby increasing production speed, reducing cost, and allowing the rigid polyurethane foam of this invention to be used in a wide variety of applications, especially those that require fast foaming times.

### DETAILED DESCRIPTION OF THE INVENTION

The present invention provides a rigid polyurethane foam (hereinafter referred to as a rigid foam). The rigid foam may be open or closed celled and typically includes a highly cross-linked, polymer structure that allows the foam to have good heat stability, high compression strength at low density, low thermal conductivity, and good barrier properties, as are well recognized by those of skill in the art. Typically, the rigid foam of this invention has a glass transition temperature greater than room temperature (˜23° C.+/−2° C. (˜73.4+/−3.6° F.)) and is typically rigid at room temperature. As generally recognized by those of skill in the art, foams are rigid at or below their glass transition temperatures especially in glassy regions of their storage moduli. In various embodiments, the rigid foam has a density of from 0.4 pcf to 50 pcf or of from 1.3 pcf to 50 pcf. In other embodiments, the rigid foam has a density greater than about 10, 15, 20, 25, 30, 35, 40, 45, 50, 55, or 60 kg/m³. In another embodiment, the rigid foam has a density of from 10 to 1,100 kg/m³. In still another embodiment, the rigid foam has a density of from 28 to 50 kg/m³. Of course, it is to be understood that the instant invention is not limited to the aforementioned values and that the rigid foam can have any whole or fractional density or range of densities within the aforementioned values.

The rigid foam also typically has one or more approximate Butler Chimney testing values (e.g. extinguish time, percent remaining, and flame height) as follows. However, it is to be understood that the rigid foam is not limited to these values and may have additional values not listed below and/or have values that differ from those below. In various embodiments, the rigid foam has an extinguish time of less than about 15 seconds, or less than about 10 to 11 seconds, as determined using ASTM D3014, thus indicating little or no burn. In other embodiments, the rigid foam has a “percent remaining” of greater than 80, 85, 88, 90, or 95 as determined using ASTM D3014. In still other embodiments, the rigid foam has a “flame height” of less than about 35 cm, 30 cm, 25 cm, 20 cm, 15 cm, 14 cm, 10 cm, or 5 cm, as determined using ASTM D3014. The rigid foam may also exhibit intumescence upon burning, as evaluated visually. In other words, the rigid foam may swell at least 1, 5, 10, 15, 20, 25, or greater percents by volume when exposed to flame. The rigid foam also is typically not friable, i.e., not brittle, when evaluated using manual scratching across a top of the foam. In one embodiment, the rigid foam has an extinguish time of less than 11 seconds, a flame height of less than 25 cm, and a percent remaining of greater than 88 percent, as determined using ASTM 3014 (Butler Chimney).

The rigid foam may also be rated as a class 1 foam evaluated using NEN 1076, part C, flash-over test. Alternatively, the rigid foam can be tested in accordance with DIN 4102 and BS476 and be rated as A1 (100% noncombustible), A2 (˜98% noncombustible), B1 (difficult to ignite), or B2 (normally combustible), pursuant to the definitions of the aforementioned tests.

The rigid foam of this invention includes the reaction product of a resin composition and an isocyanate composition. This invention also provides the resin composition itself. The resin composition includes a novolac polyol that is also known in the art as a “novolac resin” or a “phenolic polyol.” The novolac polyol is typically free of alkoxylation and has a general chemical structure as follows:

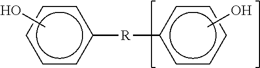

wherein R is an alkyl or alkylene group and the novolac polyol has an average hydroxyl functionality of from 2 to 30 calculated by dividing the weight average molecular weight of the novolac polyol by the equivalent weight of the novolac polyol. In one embodiment, the novolac polyol has a chemical structure as follows:

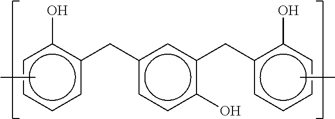

Each of the hydroxyl groups of the novolac polyol can be independently disposed in one or more of para-, ortho-, or meta-positions (most typically para- and ortho-) relative to R, e.g. relative to CH₂. Most typically, each of the hydroxyl groups is disposed in a para- or ortho-position relative to R. In one embodiment, R is a —CH₂— group but is not limited in such a way and may be any alkyl or substituted alkyl group and may be linear, branched, or cyclic. In other embodiments, R is an alkylene group and includes at least one carbon-carbon double bond. The novolac polyol is typically free of alkoxylation because alkoxylating this polyol would typically alter its physical characteristics and would tend to minimize or eliminate the novolac polyol's ability to act as an antioxidant. However, it is contemplated that the resin composition may include any amount of an alkoxylated novolac polyol.

Typically, the novolac polyol is free of alkyl groups bonded directly to the benzyl rings as the alkyl groups may contribute to flammability. For example, the novolac polyol is typically free of t-butyl and t-amyl groups. Also, the novolac polyol is typically free of catechol groups, i.e., benzyl rings with two hydroxyl groups bonded to each of one or more benzyl rings. However, it is contemplated that the resin composition may include less than 5, 1, 0.1, or 0.05 parts by weight of compounds that include t-butyl, t-amyl groups, and/or catechols.

In accordance with the aforementioned chemical structures, the novolac polyol is typically further defined as a reaction product of a phenol and formaldehyde. In one embodiment, the novolac polyol is further defined as a reaction product of bisphenol A and formaldehyde. In another embodiment, the novolac polyol is further defined as the reaction product of phenol, cresol, and formaldehyde. In still another embodiment, the novolac polyol is further defined as the reaction product of p-tert amylphenol and formaldehyde. In other embodiments, the novolac polyol is further defined as the reaction product of p-tert-butylphenol, phenol, and formaldehyde, or p-tert-butylphenol, bisphenol A, and formaldehyde. However, the novolac polyol is not limited to the aforementioned reaction products so long as the novolac polyol has the general chemical structure as described above.

As described above, the novolac polyol has an average hydroxyl functionality of from 2 to 30 calculated by dividing the weight average molecular weight of the novolac polyol by the equivalent weight of the novolac polyol. The average molecular weight is typically determined by gel permeation chromatography while the equivalent weight can be derived from a titrated hydroxyl number, as is appreciated in the art. In various embodiments, the average hydroxyl functionality is from 3 to 6, from 4 to 6, from 5 to 7, from 7 to 11, from 10 to 20, from 20 to 30, from 23 to 25, or from 23 to 27. Of course, it is to be understood that the instant invention is not limited to the aforementioned values and that the average hydroxyl functionality can be any whole or fractional amount or range of amounts within the aforementioned values. Without intending to be bound by any particular theory, it is believed that a low average hydroxyl functionality is related to a low melting point and low viscosity, which are beneficial to some embodiments of this invention. Typically, the novolac polyol is free of (i.e., has no) alkoxylation.

In various embodiments, the novolac polyol has one or more of the following approximate physical properties. However, it is to be understood that the novolac polyol is not limited to these approximate physical properties and may have additional physical properties not listed below and/or have physical properties that differ from those below.

| | Viscos. | | | | | OH Funct. | OH Funct. |
|---|---|---|---|---|---|---|---|
| Specific | (cps at | Mₙ | M_{w} | Softening | Equiv. | (Mₙ/ | (M_{w}/ |
| Gravity | 150° C.) | (g/mol) | (g/mol) | Point, ° C. | Wt | Equiv Wt) | Equiv Wt) |
| 1.26 | — | 296-300 | 450 | 60 | 102 | 2.9 | 4.4 |
| 1.24 | — | — | — | — | — | — | — |
| — | 200-600 | 330 | 570 | 65-67 | 104 | 3.2 | 5.5 |
| — | 145-170 | 440 | 810 | 70-72 | 105 | 4.2 | 7.8 |
| 1.27 | 240-440 | 500 | 1230 | 82-84 | 105 | 4.8 | 11.7 |
| — | 1400-2400 | 600 | 2500 | 95-98 | 106 | 5.7 | 23.7 |
| — | 1200-3000 | 675 | 2900 | — | 106 | 6.3 | 27.4 |
| — | 2200-400 | 675 | 2900 | 108-110 | 106 | 6.3 | 27.4 |
| 1.19 | 800-1200 | 580 | 890 | 50-62 | 116 | 5 | 7.7 |
| — | — | — | — | 82-99 | — | — | — |
| 1.06 | — | — | — | 88-99 | 179 | — | — |
| 1.28 | 1000-1700 | 970 | 2400 | 94-102 | 104 | 9.3 | 23.1 |
| 1.28 | 1200-2000 | 820 | 2630 | 98-104 | 104 | 7.9 | 25.6 |
| 1.08 | — | — | — | 102-118 | 159 | — | — |
| 1.09 | — | — | — | 104-116 | 180 | — | — |
| 1.29 | — | — | — | 110-116 | 106 | — | — |
| 1.10 | — | — | — | 143-157 | 155 | — | — |

The novolac polyol is present in the resin composition in an amount of from 3 to 65 parts by weight per 100 parts by weight of the resin composition. In one embodiment, the novolac polyol is present in an amount of from 5 to 65 parts by weight per 100 parts by weight of the resin composition. In another embodiment, the novolac polyol is present in an amount of from 10 to 60 parts by weight per 100 parts by weight of the resin composition. In still another embodiment, the novolac polyol is present in an amount of from 20 to 65 parts by weight per 100 parts by weight of the resin composition. In still other embodiments, the novolac polyol is present in amounts of from 10 to 60, 15 to 55, 20 to 50, 25 to 45, 30 to 40, 35 to 40, 1 to 10, 2 to 9, 3 to 8, 4 to 7, 5 to 6, or 5 to 10, parts by weight per 100 parts by weight of the resin composition. Without intending to be bound by any particular theory, it is believed that it would be difficult to incorporate the novolac polyol into the resin composition in amounts of greater than 60 parts by weight due to viscosity. Of course, it is to be understood that the instant invention is not limited to the aforementioned values and that the novolac polyol can be present in any whole or fractional amount or range of amounts within the aforementioned values.

In one embodiment, the novolac polyol is a solid at room temperature. In this embodiment, the novolac polyol is heated to a temperature at or above its softening point to facilitate incorporation into a non-reactive diluent or solvent or second polyol to form a pourable liquid. It is contemplated that the novolac polyol may be added as a heated liquid into the non-reactive diluent or solvent or second polyol at approximately the same temperature. Alternatively, the novolac polyol may be added directly into the resin composition which itself may be heated. The novolac resin may be entirely dissolved in the resin composition such as there are no visible particles of the novolac resin in the resin composition. Alternatively, the novolac resin may be partially dissolved in the resin composition such that particles of the novolac resin are suspended in the resin composition. The novolac polyol may be dissolved in the resin composition at elevated temperatures, e.g. temperatures above room temperature, but may be non-dissolved (or insoluble) in the resin composition at lower temperatures (e.g. room temperature and below).

Most typically, the novolac polyol is dissolved in the non-reactive diluent or solvent or the second polyol that is described in greater detail below. The non-reactive diluent or solvent may be any known in the art including, but not limited to, organic solvents, triethylphosphate, trischloropropylphosphate, dimethylpropanephosphonate, and the like. In one embodiment, the non-reactive diluent or solvent is selected from the group of ethylene glycol, diethylene glycol, dipropylene glycol, propylene carbonate, glycerin, and combinations thereof. Non-reactive diluents or solvents such as triethylphosphate, trischloropropylphosphate, and dimethylpropanephosphonate may also function as flame retardants. Alternatively, the novolac polyol may be entirely dissolved in the resin composition at room temperature and below or at temperatures above room temperature. In one embodiment, the solvent includes triethylphosphate and the novolac polyol is dissolved in the triethylphosphate at temperatures at or above about 60° C.

In one embodiment, the resin composition is free of epoxy-novolac resins (e.g. epoxy novolac resins). In other embodiments, the resin composition includes less than 1 percent, more typically of less than 0.5 percent, and most typically of less than 0.1 percent, by weight of epoxy-novolac resins in the resin composition. Epoxy-novolac resins tend to react with novolac polyols, especially in the absence of amine catalysts. Thus, if utilized, epoxy-novolac resins are typically only added immediately prior to use.

The resin composition may also include the second polyol, as first introduced above. The second polyol is different from the novolac polyol and may be any type of polyol known in the art. In various embodiments, the second polyol is selected from the group of polyester polyols, polyether polyols, and polycarbonate polyols. It is also contemplated that, for purposes of the present invention, polythioether polyols, polycaprolactones, and acrylic polyols may also be utilized. Typically, the second polyol is further defined as a polyester polyol. In one embodiment, the second polyol is further defined as an aromatic polyester polyol. In another embodiment, the second polyol is a modified phthalic acid polyester polyol.

The second polyol may be derived from a reaction of an initiator and an alkylene oxide. The initiator may include any initiator known in the art. Typically, the initiator is selected from the group of ethylene glycol, propylene glycol, dipropylene glycol, trimethylene glycol, butane diols, pentane diols, hexane diols, heptane diols, glycerol, 1,1,1-trimethylolpropane, 1,1,1-trimethylolethane, hexane triols, alkyl glucosides, pentaerythritol, sorbitol, diamine naphthalenes, anilines, condensation products of aniline and formaldehyde, alkyl amines, triisopropanolamine, alkylene diamines, diamine alkanes, sucrose, toluene diamine, and combinations thereof.

The alkylene oxide that reacts with the initiator to form the polyol may be selected from the group of ethylene oxide, propylene oxide, butylene oxide, amylene oxide, tetrahydrofuran, alkylene oxide-tetrahydrofuran mixtures, epihalohydrins, aralkylene oxides, and combinations thereof. In various embodiments, the alkylene oxide is selected from the group of ethylene oxide, propylene oxide, and combinations thereof. However, it is also contemplated that any suitable alkylene oxide that is known in the art may be used in the present invention.

The second polyol may include an organic functional group selected from the group of a carboxyl group, an amine group, a carbamate group, an amide group, and an epoxy group. The second polyol may also include an alkylene oxide cap. If the second polyol includes the alkylene oxide cap, the alkylene oxide cap typically includes, but is not limited to, ethylene oxide, propylene oxide, butylene oxide, amylene oxide, and combinations thereof. More typically, the alkylene oxide cap includes ethylene oxide. If the second polyol includes the alkylene oxide cap, the alkylene oxide cap is typically less than or equal to 25, and more typically of from 10 to 20, percent by weight based on the total weight of the second polyol.

The second polyol typically has a number average molecular weight of from 200 to 10,000 g/mol, a hydroxyl number of from 10 to 1,000 mg KOH/g, and a nominal functionality of from 1 to 8. In various embodiments, the optional second is selected from the group of sucrose initiated polyols, Mannich polyols, and combinations thereof. The second polyol also typically has a viscosity from 20 to 50,000 centipoises at 77° F.

In one embodiment, the second polyol has a hydroxyl number of from 200 to 350 mg KOH/g. In other embodiments, the second polyol has a hydroxyl number of from 200 to 320, 220 to 350, of about 200, 240, 245, 250, 255, 260, 265, 270, 275, 280, 285, 290, 300, 305, 310, 315, 320, 325, 330, 335, 340, or 350, mg KOH/g. Suitable examples of the second polyol include, but are not limited to, aromatic polyester polyols commercially available from Oxid, L.P. of Houston, Tex. under the trade names of Terol® 11, 250, 256, 258, 305, 350, 352, 353, 375, 563, 925, and 1154. Of course, it is to be understood that the instant invention is not limited to the aforementioned values and that the hydroxyl number can be any whole or fractional amount or range of amounts within the aforementioned values.

However, the second polyol is not limited to the aforementioned number average or weight average molecular weights, hydroxyl numbers, functionalities, and viscosities. In various embodiments, the novolac polyol is present in the resin composition in an amount of greater than 20, 25, 30, 35, 40, 45, or 50 parts by weight per 100 parts by weight of the second polyol. Of course, it is to be understood that the instant invention is not limited to the aforementioned values and that the second polyol can be present in any whole or fractional amount or range of amounts within the aforementioned values.

The second polyol may also include an addition polymer dispersed therein. More specifically, the second polyol may include a dispersion or a solution of addition or condensation polymers, i.e., a graft polyol. The dispersion may include styrene, acrylonitrile, and combinations thereof. Also, the second polyol may also include an emulsion that includes water or any other polar compound known in the art.

The resin composition may also include an amine, which may be any type known in the art. The amine may include, but is not limited to, primary and secondary amines aliphatic and/or cyclic aliphatic amines. The amine may include any additional functional group known in the art including, but not limited to, hydroxyl groups, thiol groups, alkyl groups, cyclic groups, aromatic groups, and combinations thereof. It is to be understood that the amine may also include an amide which also may be any type known in the art. The amide may include, but is not limited to, polyester amides obtained from polymers of unsaturated or saturated carboxylic acids or anhydrides, and multifunctional unsaturated or saturated amino-alcohols, and combinations thereof.

The resin composition may also include a third polyol that is different from the novolac polyol and from the second polyol. The third polyol may also be any known in the art and may be a polyether polyol, a polyester polyol, or combinations thereof. In one embodiment, the third polyol is a polyester polyol. In this embodiment, the third polyol may also be a Terol®, as described above.

In various embodiments, the third polyol is present in amounts of from 0.1 to 20, of from 1 to 15, of from 1 to 10, of from 2 to 8, of from 3 to 7, of from 4 to 6, or of from 5 to 6, parts by weight per 100 parts by weight of the resin composition. However, it is to be understood that the invention is not limited to such amounts. Of course, it is to be understood that the instant invention is not limited to the aforementioned values and that the third polyol can be present in any whole or fractional amount or range of amounts within the aforementioned values.

The resin composition may also include a flame retardant. The flame retardant may be included in the resin composition to provide increased flame retardancy of the rigid foam in various applications. In commercial applications, those skilled in the art may select whether to include the flame retardant to the resin composition. It is also to be understood that the resin composition may include a plurality of flame retardants. In various embodiments, the flame retardant is present in amounts of from 5 to 50, of from 10 to 45, of from 15 to 35, of from 20 to 30, or of from 25 to 30, parts by weight per 100 parts by weight of the resin composition. Of course, it is to be understood that the instant invention is not limited to the aforementioned values and that the flame retardant can be present in any whole or fractional amount or range of amounts within the aforementioned values.

In various embodiments, the flame retardant is selected from the group of phosphorous, halogens, and combinations thereof. If included, the flame retardant is more typically selected from the group of phosphorous, bromine, and combinations thereof. Examples of suitable flame retardants include, but are not limited to, red phosphorus, ammonium polyphosphate, tris(2-chloroethyl)phosphate, tris(2-chloropropyl)phosphate, tetrakis(2-chloroethyl)ethylene diphosphate, dimethyl methane phosphonate, dimethylpropanephosphonate, diethyl diethanolaminomethylphosphonate, and combinations thereof. In another embodiment, the flame retardant is selected from the group of tricresyl phosphate, tris(2-chloroethyl)phosphate, tris(2-chloropropyl)phosphate, tris(2,3-dibromopropyl)phosphate, red phosphorous, aluminum oxide hydrate, antimony trioxide, arsenic oxide, ammonium polyphosphate and calcium sulfate, molybdenum trioxide, ammonium molybdate, ammonium phosphate, pentabromodiphenyloxide, 2,3-dibromopropanol, hexabromocyclododecane, dibromoethyldibromocyclohexane, expandable graphite or cyanuric acid derivatives, melamine, and corn starch. Additionally, other supplemental flame retardants are also contemplated for use in the present invention including, but not limited to, hydrated aluminum oxide, calcium sulfate, expanded graphite, cyanuric acid derivatives, and combinations thereof. In various embodiments, the resin composition is free of or substantially free of halogenated flame retardants. The terminology “substantially free” typically refers to the resin composition including less than 1, more typically less than 0.5, and most typically less than 0.1, percent by weight of the halogenated flame retardants per 100 parts by weight of the resin composition.

The resin composition may also include one or more catalysts such as polymerization catalysts. Polymerization catalysts typically catalyze the reaction of the novolac polyol (and optionally the second and third polyols) and the isocyanate composition. The catalyst may include one or more catalysts and typically includes a combination of catalysts. The catalyst is typically present to catalyze the exothermic reaction between the resin composition and the isocyanate composition. It is to be appreciated that the catalyst is typically not consumed in, the exothermic reaction. That is, the catalyst typically participates in, but is not consumed in the exothermic reaction. The catalyst may include any suitable catalyst or mixtures of catalysts known in the art. Examples of suitable catalysts include, but are not limited to, gelation catalysts, e.g. amine catalysts in dipropylene glycol; blowing catalysts, e.g. bis(dimethylaminoethyl)ether in dipropylene glycol; and metal catalysts, e.g. tin, bismuth, lead, etc. If included, the catalyst can be included in various amounts. In one embodiment, the catalyst is selected from the group of, tin, iron, lead, bismuth, mercury, titanium, hafnium, zirconium, iron(II) chloride, zinc chloride, lead octoate stabilized stannous octoate, tin(II) salts of organic carboxylic acids such as tin(II) acetate, tin(II) octoate, tin(II) ethylhexanoate and tin(II) laurate, and dialkyltin(IV) salts of organic carboxylic acids such as dibutyltin dilaurate, dibutyltin diacetate, dibutyltin maleate and dioctyltin diacetate, and combinations thereof.

Additionally, any of the aforementioned polymerization catalysts may be combined with amines including, but not limited to, amidines such as 2,3-dimethyl-3,4,5,6-tetrahydropyrimidine, tertiary amines such as triethylamine, tributylamine, dimethylbenzylamine, N-methylmorpholine, S-ethylmorpholine, N-cyclohexylmorpholine, N,N,N′,N′-tetramethylethylenediamine, N,N,N′,N′-tetramethylbutanediamine, N,N,N′,N′-tetamethylhexane-1,6-diamine, pentamethyldiethylenetriamine, bis(dimethylaminoethyl)ether, bis(dimethylaminopropyl)urea dimethylpiperazine, 1,2-dimethylimidazole, 1-azabicyclo[3.3.0]octane and typically 1,4-diazabicyclo[2.2.2]octane, and alkanolamine compounds such as triethanolamine, triisopropanolamine, N-methyldiethanolamine and N-ethyldiethanolamine and dimethylethanolamine.

Further, other suitable polymerization catalysts that are contemplated for use in the present invention include, but are not limited to, tris(dialkylaminoalkyl)-s-hexahydrotriazines, including tris(N,N-dimethylaminopropyl)-s-hexahydrotriazine, tetraalkylammonium hydroxides including tetramethylammonium hydroxide, alkali metal hydroxides including sodium hydroxide and potassium hydroxide, alkali metal alkoxides including sodium methoxide and potassium isopropoxide, and alkali metal salts of long-chain fatty acids having from 10 to 20 carbon atoms and/or lateral OH groups. A particular polymerization catalyst or combination of polymerization catalysts may be chosen by one skilled in the art.

In various embodiments, the polymerization catalyst is included in amounts of from 0.01 to 10, of from 2 to 4, of from 2 to 6, of from 3 to 7, of from 0.2 to 0.6, of from 0.6 to 0.9, of from 0.3 to 0.5, or of from 0.9 to 1.2, parts by weight per 100 parts by weight of the resin composition. Of course, it is to be understood that the instant invention is not limited to the aforementioned values and that the polymerization catalyst can be present in any whole or fractional amount or range of amounts within the aforementioned values.

The resin composition may also include one or more blowing agents including, but not limited to, physical blowing agents, chemical blowing agents, or a combinations thereof. In one embodiment, the blowing agent includes both a physical blowing agent and a chemical blowing agent, and the blowing agent is included in the resin composition. The physical blowing agent does not typically chemically react with the resin composition and/or the isocyanate to provide a blowing gas. The physical blowing agent can be a gas or liquid. The physical blowing agent that is liquid typically evaporates into a gas when heated, and typically returns to a liquid when cooled. The physical blowing agent typically reduces the thermal conductivity of the rigid polyurethane foam. The blowing agent may include, but is not limited methylene chloride, formic acid, acetone, and liquid carbon dioxide, aliphatic and/or cycloaliphatic hydrocarbons such as halogenated hydrocarbons and alkanes, acetals, water, alcohols, glycerol, formic acid, and combinations thereof.

In various embodiments, the blowing agent is selected from the group of volatile non-halogenated C₂-C₇ hydrocarbons such as alkanes, alkenes, cycloalkanes having up to 6 carbon atoms, dialkyl ether, cycloalkylene ethers and ketones, and hydrofluorocarbons, C₁-C₄ hydrofluorocarbons, volatile non-halogenated hydrocarbon such as linear or branched alkanes such as butane, isobutane, 2,3-dimethylbutane, n- and isopentanes, n- and isohexanes, n- and isoheptanes, n- and isooctanes, n- and isononanes, n- and isodecanes, n- and isoundecanes, and n- and isodedecanes, alkenes such as 1-pentene, 2-methylbutene, 3-methylbutene, and 1-hexene, cycloalkanes such as cyclobutane, cyclopentane, and cyclohexane, linear and/or cyclic ethers such as dimethyl ether, diethyl ether, methyl ethyl ether, vinyl methyl ether, vinyl ethyl ether, divinyl ether, tetrahydrofuran and furan, ketones such as acetone, methyl ethyl ketone and cyclopentanone, isomers thereof, hydrofluorocarbons such as difluoromethane (HFC-32), 1,1,1,2-tetrafluoroethane (HFC-134a), 1,1,2,2-tetrafluoroethane (HFC-134), 1,1-difluoroethane (HFC-152a), 1,2-difluoroethane (HFC-142), trifluoromethane, heptafluoropropane (R-227a), hexafluoropropane (R-136), 1,1,1-trifluoro ethane, 1,1,2-trifluoroethane, fluoroethane (R-161), 1,1,1,2,2-pentafluoropropane, pentafluoropropylene (R-2125a), 1,1,1,3-tetrafluoropropane, tetrafluoropropylene (R-2134a), difluoropropylene (R-2152b), 1,1,2,3,3-pentafluoropropane, 1,1,1,3,3-pentafluoro-n-butane, and 1,1,1,3,3-pentafluoropentane (245fa), isomers thereof, 1,1,1,2-tetrafluoroethane (HFC-134a), isomers thereof, and combinations thereof. In various embodiments, the blowing agent is further defined as 1,1,1,3,3-pentafluoropentane (245fa). In an alternative embodiment, the blowing agent is further defined as 365 MFC, which may be blended with 227ea.

In various embodiments, the blowing agent, e.g. 1,1,1,3,3-pentafluoropentane (245fa), is present in amounts of from 1 to 20, of from 9 to 17, of from 10 to 20, of from 5 to 15, of from 5 to 10, or of from 15 to 20, parts by weight per 100 parts by weight of the resin composition. In other embodiments, the blowing agent, e.g. water, is present in amounts of from 1 to 5, of from 1 to 2.5, of from 1 to 1.9, of from 1 to 1.4, of from 1.4 to 1.8, or of from 2.1 to 2.5, parts by weight per 100 parts by weight of the resin composition. It is also contemplated that both a non-water blowing agent and water may be present simultaneously in one or more of the above amounts. Of course, it is to be understood that the instant invention is not limited to the aforementioned values and that one or more of the blowing agents and/or water can be present in any whole or fractional amount or range of amounts within the aforementioned values. Typically, the amount of the blowing agent and/or water is selected based on a desired density of the rigid foam and solubility of the blowing agent in the resin composition. It is desirable to minimize amounts of the blowing agent used to reduce costs.

The resin composition may also include one or more blowing catalysts. Particularly suitable non-limiting examples of blowing catalysts include catalysts such as DABCO® BL-17, DABCO® BL-19, DABCO® BL-11, DABCO® BL-22, DABCO® BLX-11, DABCO® BLX-13, DABCO® NE 210, DABCO® NE 600, DABCO® T, Polycat® 36, Polycat® 41, Polycat® 5, Polycat® 77, and the like, and combinations thereof.

In various embodiments, the blowing catalyst is included in amounts of from 0.01 to 10, of from 2 to 4, of from 2 to 6, of from 3 to 7, of from 0.2 to 0.6, of from 0.6 to 0.9, of from 0.3 to 0.5, or of from 0.9 to 1.2, parts by weight per 100 parts by weight of the resin composition. Of course, it is to be understood that the instant invention is not limited to the aforementioned values and that the blowing catalyst can be present in any whole or fractional amount or range of amounts within the aforementioned values. Without intending to be bound by any particular theory, it is believed that the blowing catalyst unexpectedly catalyzes a reaction of the isocyanate composition and the novolac polyol over the reaction of the isocyanate composition and water and, as such, may not behave as a “typical” blowing catalyst.

The resin composition may also include a silicone, such as a silicone surfactant. Typically, silicone surfactants control cell size and shape of the rigid foam produced from the reaction of the resin composition and isocyanate composition. The silicone surfactant may include, but is not limited to, bulk and surface silicone surfactants and combinations thereof. In various embodiments, the silicone surfactant is commercially available from Air Products under the trade name of DABCO® DC 193. In various embodiments, the silicone surfactant is present in amounts of from 0.5 to 5, of from 0.5 to 4, of from 1 to 3, or in about 2, parts by weight per 100 parts by weight of the resin composition. Of course, it is to be understood that the instant invention is not limited to the aforementioned values and that the silicone surfactant can be present in any whole or fractional amount or range of amounts within the aforementioned values.

The resin composition may also include a non-silicone surfactant. The non-silicone surfactant may be used with the bulk and surface silicone surfactants or alone. Any surfactant known in the art may be used in the present invention. As such, the surfactant may include non-ionic surfactants, cationic surfactants, anionic surfactants, amphoteric surfactants, and combinations thereof. In various embodiments, the surfactant typically includes, but is not limited to, polyoxyalkylene polyol surfactants, alkylphenol ethoxylate surfactants, and combinations thereof. In one embodiment, the surfactant includes, but is not limited to, commercial surfactants including Pluronic® polyethers and Tetronic® polyethers commercially available from the BASF Corporation of Wyandotte, Mich. If the surfactant is included in the resin composition, the surfactant may be present in any amount.

In still another embodiment, the resin composition includes a surfactant that is selected from the group of silicone surfactants, salts of sulfonic acids, e.g. alkali metal and/or ammonium salts of oleic acid, stearic acid, dodecylbenzene- or dinaphthylmethane-disulfonic acid, and ricinoleic acid, foam stabilizers such as siloxaneoxyalkylene copolymers and other organopolysiloxanes, oxyethylated alkyl-phenols, oxyethylated fatty alcohols, paraffin oils, castor oil, castor oil esters, and ricinoleic acid esters, and cell regulators, such as paraffins, fatty alcohols, dimethylpolysiloxanes, and combinations thereof.

The resin composition may also include a cross-linker and/or a chain extender. The cross-linker may include, but is not limited to, an additional polyol, amines, and combinations thereof. If the cross-linker is included in the resin composition, the cross-linker may be present in any amount. Chain extenders contemplated for use in the present invention include, but not limited to, hydrazine, primary and secondary diamines, alcohols, amino acids, hydroxy acids, glycols, and combinations thereof. Specific chain extenders that are contemplated for use include, but are not limited to, mono and di-ethylene glycols, mono and di-propylene glycols, 1,4-butane diol, 1,3-butane diol, propylene glycol, dipropylene glycol, diethylene glycol, methyl propylene diol, mono, di and tri-ethanolamines, N-N′-bis-(2 hydroxy-propylaniline), trimethylolpropane, glycerine, hydroquinone bis(2-hydroxyethyl)ether, 4,4′-methylene-bis(2-chloroaniline, diethyltoluenediamine, 3,5-dimethylthio-toluenediamine, hydrazine, isophorone diamine, adipic acid, silanes, and combinations thereof. If included in the resin composition, the chain-extender may be present in any amount.

The resin composition may also include one or more additives. Suitable additives include, but are not limited to, chain terminators, inert diluents, amines, anti-foaming agents, air releasing agents, wetting agents, surface modifiers, waxes, inert inorganic fillers, molecular sieves, reactive inorganic fillers, chopped glass, other types of glass such as glass mat, processing additives, surface-active agents, adhesion promoters, anti-oxidants, dyes, pigments, ultraviolet light stabilizers, thixotropic agents, anti-aging agents, lubricants, adhesion promoters, coupling agents, solvents, rheology promoters, and combinations thereof. The one or more additives can be present in the resin composition in any amount.

Referring back to the isocyanate composition first introduced above, the isocyanate composition includes at least one isocyanate and may include more than one isocyanate. The isocyanate composition typically includes an aromatic isocyanate, an aliphatic isocyanate, and/or combinations thereof. Most typically, the isocyanate composition includes an aromatic isocyanate such as polymeric MDI. If the isocyanate composition includes an aromatic isocyanate, the aromatic isocyanate typically corresponds to the formula R′ (NCO)_{z} wherein R′ is a polyvalent organic radical which is aromatic and z is an integer that corresponds to the valence of R′. Typically, z is at least two.

The isocyanate composition may include, but is not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof.

If the isocyanate composition includes an aromatic isocyanate, the isocyanate composition may also include a modified multivalent aromatic isocyanate, i.e., a product which is obtained through chemical reactions of aromatic diisocyanates and/or aromatic polyisocyanates. Examples include polyisocyanates including, but not limited to, ureas, biurets, allophanates, carbodiimides, uretonimines, and isocyanurate and/or urethane groups including diisocyanates and/or polyisocyanates such as modified diphenylmethane diisocyanates. The urethane groups of the isocyanate may be formed through reaction of a base isocyanate, as described above, with low molecular weight diols, triols, dialkylene glycols, trialkylene glycols, polyoxyalkylene glycols with a number average molecular weight of up to 1500 g/mol, diethylene glycol, dipropylene glycol, polyoxyethylene glycol, polyoxypropylene glycol, polyoxyethylene glycol, polyoxypropylene glycol, and/or polyoxypropylene polyoxyethylene glycols or -triols, and combinations thereof. The isocyanate may also include one or more prepolymers including isocyanate groups.

The isocyanate composition may also include, but is not limited to, modified benzene and toluene diisocyanates, employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof. In various embodiments, the isocyanate composition includes an isocyanate that is selected from the group of 2,4′-diphenylmethane diisocyanate, 4,4′-diphenylmethane diisocyanate, modified 2,4′-diphenylmethane diisocyanate, modified 4,4′-diphenylmethane diisocyanate, and combinations thereof. The isocyanate composition may also include stoichiometric or non-stoichiometric reaction products of the aforementioned isocyanates.

Alternatively, the isocyanate composition may include a liquid polyisocyanate including one or more carbodiimide groups. In various embodiments, crude polyisocyanates may also be used, such as crude toluene diisocyanate obtained by the phosgenation of a mixture of toluenediamines or crude diphenylmethane isocyanate obtained by the phosgenation of crude isocyanates.

The isocyanate is not limited in NCO content, typically has an NCO content of from 5 to 35 percent by weight, and more typically has an NCO content of about 31.5±2, percent by weight. Determination of the NCO content on percent by weight is accomplished by a standard chemical titration analysis known to those skilled in the art. Also, the isocyanate typically is not limited by, but typically has a calculated functionality of from 1.7 to 3.0 and more typically of from 2.7 to 2.9. Still further, the isocyanate typically has a viscosity of from 15 to 2000 cps at 25° C.

In addition to the rigid foam and the resin composition, this invention also provides a method of forming resin composition, a method of forming the rigid foam, and a method of forming the rigid foam on a surface. The method of forming the resin composition typically includes the steps of combining the novolac resin and one or more of the second polyol, the third polyol, and/or any one or more of the additives or other components described above.

The method of forming the rigid foam typically includes the step of combining the resin composition and the isocyanate composition. Most typically, the resin composition and the isocyanate composition are combined such that the isocyanate index is from about 90 to about 300, from about 90 to about 140, or from about 105 to about 140. In various embodiments, the isocyanate index is from about 110 to about 120, from about 120 to about 130, from about 130 to about 140, from about 115 to about 125, or from about 125 to about 135. In still other embodiments, the isocyanate index is from about 140 to about 300, from about 150 to about 300, from about 160 to about 290, from about 170 to about 280, from about 180 to about 270, from about 190 to about 260, from about 200 to about 250, from about 210 to about 240, or from about 220 to about 230, e.g. in continuous line applications. It is to be understood that the isocyanate index may be present in any amount or range of amounts within the aforementioned ranges.

The method of forming the rigid foam on the surface typically includes the steps of providing the resin composition and the isocyanate composition, combining the resin composition and the isocyanate composition to form a mixture, and applying the mixture to the surface to form the rigid foam on the surface. In one embodiment, the method of forming the rigid foam on the surface includes the steps of providing the resin composition, providing the isocyanate composition, and combining the resin composition and the isocyanate composition to form the rigid polyurethane foam on the surface. The resin composition and the isocyanate composition may be combined while on the surface or apart from the surface. In one embodiment, the resin composition and the isocyanate composition are combined in the head of a spray gun or in the air above the surface. The resin composition and the isocyanate composition may be combined and applied to the surface by any method known in the art including spraying, dipping, pouring, coating, painting, etc.

The surface upon which the mixture is applied may be any surface. In various embodiments, the surface is of a residential or commercial structure or building, such as a single or multiple family home, a modular home, or a business. In other embodiments, the surface is a wall, floor, roof, or ceiling of the building. In still other embodiments, the surface is of an appliance, a mechanical device, or a stationary object. The surface upon which the mixture is applied may be, but is not limited to, brick, concrete, masonry, dry-wall, sheetrock, plaster, metal, stone, wood, plastic, a polymer composite, or combinations thereof. It is also contemplated that the surface upon which the mixture is sprayed may be a surface of a vehicle or machine component. In addition, the surface may be further defined as a surface of a mold and the rigid foam may be formed in mold. Typically, in such applications, the rigid foam is used in construction and/or commercial applications but is not limited to use in these applications. Non-limiting steps that may be associated with forming the rigid foam in the mold include applying a mold release agent to the mold, applying a first layer to the mold that may be a show surface of the rigid foam, applying a backing layer to the rigid foam, pouring the resin composition and/or the isocyanate composition into the mold, and/or combinations thereof.

The method typically includes the steps of providing the resin composition and providing the isocyanate composition. In other words, both the resin composition and the isocyanate composition are supplied for use in the method. Typically, the resin composition and the isocyanate composition are formulated off-site and then delivered to an area where they are used. In one embodiment, the method includes the step of heating the resin composition and the isocyanate composition to a temperature of from 70° F. to 95° F. In other embodiments, the temperature is further defined as from 100° F. to 140° F. or from 120° F. to 125° F.

The resin composition and the isocyanate composition may be combined by any means known in the art to form the mixture. Typically, the step of combining occurs in a mixing apparatus such as a static mixer, impingement mixing chamber, or a mixing pump. In one embodiment, the step of mixing occurs in a static mixing tube. Alternatively, the resin composition and the isocyanate composition may be combined in a spray nozzle.

In one embodiment, the resin composition and the isocyanate composition are combined with a stream of air typically having a pressure of from 1 to 5 psi. It is contemplated that the isocyanate composition may be combined with the stream of air before being combined with the resin composition. Alternatively, the resin composition may be combined with the stream of air before being combined with the isocyanate composition. Further, the resin composition and the isocyanate composition may be combined simultaneously with the stream of air. The stream of air is thought to aid in mixing and promote even spraying and distribution of the mixture.

The method also includes the step of applying the mixture onto the surface to form the rigid foam thereon. Typically, the mixture is sprayed at a spray rate of from 1 to 30 lbs/min, more typically at a rate of from 5 to 25 lbs/min, and even more typically at a rate of from 5 to 20, lbs/min. Also, the mixture is typically sprayed at a pressure of less than 3000 psi. It is contemplated that the mixture may be sprayed at any rate or range of rates within the ranges set forth above. Similarly, it is contemplated that the mixture may be sprayed at any pressure or range of pressures within the ranges set forth above.

In various embodiments, the resin composition and the isocyanate composition may be sprayed at a thickness of up to about 10 inches, in a single pass, with minimal or no visible discoloration (e.g. yellowing) or scorch in/on the rigid foam formed from the reaction. In various other embodiments, the resin composition and the isocyanate composition are sprayed in a single pass such that the rigid foam being formed therefrom has a (single pass) thickness of from 1 to 10, from 2 to 8, from 3 to 7, from 4 to 6, from 4 to 5, or of from 6 to 9, inches, with minimal or no visible discoloration and/or scorch

### EXAMPLES

A series of rigid polyurethane foams (Foams 1-85) are formed according to the instant invention. A series of comparative rigid polyurethane foams (Comparative Foams 1-12) are also attempted but not according to this invention. The Comparative Foams 1 and 2 are not formed using any novolac polyol of this invention. Instead, the Comparative Foams 1-2 are formed using only a phosphorous flame retardant. The resin compositions and isocyanate compositions, along with the reaction conditions, used to form the Foams 1-85 and the Comparative Foams 1-12 are set forth in Table 1 below.

After formation, many of the foams are evaluated to determine friability and intumescence. Many of the foams are also evaluated for flammability using a Butler Chimney according to ASTM D-3014 which, as is known in the art, has a most positive/“best”value of 10 seconds indicating that the foam does not support flame at all and that upon removal of a source of flame any flame on the foam extinguishes immediately. These evaluations are also set forth in Table 1 below.

TABLE 1

| | Foam 1 | Foam 2 | Foam 3 | Foam 4 |
|---|---|---|---|---|
| Resin Composition | | | | |
| Novolac Polyol 1 | — | 40.4 | 43.2 | 43.0 |
| Novolac Polyol 2 | 40.4 | — | — | — |
| Optional Polyol 1 | — | — | — | — |
| Flame Retardant 1 | 40.4 | 40.4 | 43.2 | 43.0 |
| Surfactant 1 | 2.0 | 2.0 | 2.0 | 2.0 |
| Catalyst 1 | 0.2 | 0.2 | 0.2 | 0.2 |
| Blowing Agent 1 | — | — | 1.4 | 1.8 |
| Blowing Agent 2 | 17.0 | 17.0 | 10.0 | 10.0 |
| Total | 100.0 | 100.0 | 100.0 | 100.0 |
| Resin Eq. Wt. | 257.22 | 249.72 | 171.39 | 159.78 |
| Resin Sp. Gr. | 1.183 | 1.178 | 1.165 | 1.162 |
| Isocyanate | Isocyanate 1 | Isocyanate 1 | Isocyanate 1 | Isocyanate 1 |
| Composition | | | | |
| Iso. Equiv. Wt. | 135.1 | 135.1 | 135.1 | 135.1 |
| Iso Sp. Gr. | 1.245 | 1.245 | 1.245 | 1.245 |
| Hand-Mix Parameters | Spatula Mix | Spatula Mix | Spatula Mix | Spatula Mix |
| Resin Wt. (g) | 25 | 25 | 25 | 25 |
| Iso. Wt. (g) | 13.8 | 14 | 20.4 | 28.6 |
| Hand Mix Ratio (g) | 55.20 | 56.00 | 81.60 | 114.40 |
| Isocyanate Index | 105.10 | 103.51 | 103.52 | 135.28 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |

| | Foam 5 | Foam 6 | Foam 7 |
|---|---|---|---|
| Resin Composition | | | |
| Novolac Polyol 1 | 42.8 | 59.9 | 20.0 |
| Novolac Polyol 2 | — | — | — |
| Optional Polyol 1 | — | — | 45.6 |
| Flame Retardant 1 | 42.8 | 25.7 | 20.0 |
| Surfactant 1 | 2.0 | 2.0 | 2.0 |
| Catalyst 1 | 0.6 | 0.6 | 0.6 |
| Blowing Agent 1 | 1.8 | 1.8 | 1.8 |
| Blowing Agent 2 | 10.0 | 10.0 | 10.0 |
| Total | 100.0 | 100.0 | 100.0 |
| Resin Eq. Wt. | 159.39 | 125.75 | 161.49 |
| Resin Sp. Gr. | 1.162 | 1.164 | 1.197 |
| Isocyanate | Isocyanate 1 | Isocyanate 1 | Isocyanate 1 |
| Composition | | | |
| Iso. Equiv. Wt. | 135.1 | 135.1 | 135.1 |
| Iso Sp. Gr. | 1.245 | 1.245 | 1.245 |
| Hand-Mix Parameters | Spatula Mix | Spatula Mix | Livonia Mixer |
| | | | 3100 RPM |
| Resin Wt. (g) | 25 | 25 | 73.75 |
| Iso. Wt. (g) | 26.8 | 27.8 | 76.25 |
| Hand Mix Ratio (g) | 107.20 | 111.20 | 103.39 |
| Isocyanate Index | 128.47 | 103.50 | 123.59 |
| Foam Properties | | | |
| Friability | No | No | No |
| Intumescence | Yes | Yes | Yes |
| Butler Chimney | | | |
| Percent Remaining | N/A | N/A | 94.82 |
| Extinguish Time (s) | N/A | N/A | 11 |
| Flame Height (cm) | N/A | N/A | 14 |

| | Foam 8 | Foam 9 | Foam 10 | Foam 11 |
|---|---|---|---|---|
| Resin Composition | | | | |
| Novolac Polyol 1 | 30.0 | 51.4 | 37.5 | 45.0 |
| Optional Polyol 1 | 35.6 | — | 22.8 | 10.3 |
| Flame Retardant 1 | 20.0 | 34.2 | 25.0 | 30.0 |
| Surfactant 1 | 2.0 | 2.0 | 2.0 | 2.0 |
| Catalyst 1 | 0.6 | — | 0.6 | 0.6 |
| Catalyst 2 | 0.3 | 0.5 | 0.3 | 0.3 |
| Blowing Agent 1 | 1.8 | 1.8 | 1.8 | 1.8 |
| Blowing Agent 2 | 10.0 | 10.0 | 10.0 | 10.0 |
| Total | 100.3 | 99.9 | 100.0 | 100.0 |
| Resin Eq. Wt. | 149.24 | 141.6 | 146.39 | 143.35 |
| Resin Sp. Gr. | 1.206 | 1.178 | 1.195 | 1.186 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | Livonia Mixer | Livonia Mixer | Livonia Mixer | Livonia Mixer |
| Parameters | 3100 RPM | 3100 RPM | 3100 RPM | 3100 RPM |
| Resin Wt. (g) | 73.75 | 50 | 50.12 | 75.45 |
| Iso. Wt. (g) | 76.25 | 52.2 | 52.08 | 79.88 |
| Hand Mix Ratio (g) | 103.39 | 104.40 | 103.91 | 105.87 |
| Isocyanate Index | 115.68 | 110.83 | 114.04 | 113.78 |
| Properties of Foams | | | | |
| Friability | No | No | No | No |
| Intumescence | Yes | Yes | Yes | Yes |
| Butler Chimney | | | | |
| Percent Remaining | 94.35 | N/A | 94.10 | 93.21 |
| Extinguish Time (s) | 11 | N/A | 10 | 10 |
| Flame Height (cm) | 16 | N/A | 25 | 25 |
| | Foam 12 | Foam 13 | Foam 14 | Foam 15 |
| Resin Composition | | | | |
| Novolac Polyol 1 | 25.0 | 37.5 | — | — |
| Novolac Polyol 2 | — | — | 37.5 | — |
| Novolac Polyol 3 | — | — | — | 37.5 |
| Optional Polyol 1 | 35.3 | 10.3 | 10.3 | 10.3 |
| Flame Retardant 1 | 25.0 | 37.5 | 37.5 | 37.5 |
| Surfactant 1 | 2.0 | 2.0 | 2.0 | 2.0 |
| Catalyst 1 | 0.6 | 0.6 | 0.6 | 0.6 |
| Catalyst 2 | 0.3 | 0.3 | 0.3 | 0.3 |
| Blowing Agent 1 | 1.8 | 1.8 | 1.8 | 1.8 |
| Blowing Agent 2 | 10.0 | 10.0 | 10.0 | 10.0 |
| Total | 100.0 | 100.0 | 100.0 | 100.0 |
| Resin Eq. Wt. | 161.39 | 160.24 | 163.07 | 172.5 |
| Resin Sp. Gr. | 1.195 | 1.172 | 1.177 | 1.149 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | Livonia Mixer | Livonia Mixer | Livonia Mixer | Livonia Mixer |
| Parameters | 3100 RPM | 3100 RPM | 3100 RPM | 3100 RPM |
| Resin Wt. (g) | 50.07 | 76.75 | 77.75 | 86.37 |
| Iso. Wt. (g) | 52.22 | 81.57 | 82.25 | 93.63 |
| Hand Mix Ratio (g) | 104.29 | 106.28 | 105.79 | 106.41 |
| Isocyanate Index | 126.19 | 127.67 | 129.33 | 140.19 |
| Properties of Foams | | | | |
| Friability | No | No | No | No |
| Intumescence | Yes | Yes | Yes | Yes |
| Butler Chimney | | | | |
| Percent Remaining | 93.37 | N/A | N/A | 88.98 |
| Extinguish Time (s) | 10 | N/A | N/A | 11 |
| Flame Height (cm) | 25 | N/A | N/A | 23 |
| | Foam 16 | Foam 17 | Foam 18 | Foam 19 |
| Resin Composition | | | | |
| Novolac Polyol 4 | 37.5 | — | — | — |
| Novolac Polyol 5 | — | 37.5 | — | — |
| Novolac Polyol 6 | — | — | 37.5 | — |
| Novolac Polyol 7 | — | — | — | 37.5 |
| Optional Polyol 1 | 10.3 | 10.3 | 10.3 | 10.3 |
| Flame Retardant 1 | 37.5 | 37.5 | 37.5 | 37.5 |
| Surfactant 1 | 2.0 | 2.0 | 2.0 | 2.0 |
| Catalyst 1 | 0.6 | 0.6 | 0.6 | 0.6 |
| Catalyst 2 | 0.3 | 0.3 | 0.3 | 0.3 |
| Blowing Agent 1 | 1.8 | 1.8 | 1.8 | 1.8 |
| Blowing Agent 2 | 10.0 | 10.0 | 10.0 | 10.0 |
| Total | 100.0 | 100.0 | 100.0 | 100.0 |
| Resin Eq. Wt. | 214.74 | 203.75 | 215.17 | 215.7 |
| Resin Sp. Gr. | 1.100 | 1.109 | 1.114 | 1.119 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | Livonia Mixer | Livonia Mixer | Livonia Mixer | Livonia Mixer |
| Parameters | 3100 RPM | 3100 RPM | 3100 RPM | 3100 RPM |
| Resin Wt. (g) | 103.15 | 100.78 | 103.21 | 103.33 |
| Iso. Wt. (g) | 76.85 | 79.22 | 76.79 | 76.67 |
| Hand Mix Ratio (g) | 74.50 | 78.61 | 74.40 | 74.20 |
| Isocyanate Index | 199.94 | 120.07 | 120.02 | 119.98 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 20 | Foam 21 | Foam 22 | Foam 23 |
| Resin Composition | | | | |
| Novolac Polyol 2 | 20.0 | — | — | 20.0 |
| Novolac Polyol 8 | — | 20.0 | — | — |
| Novolac Polyol 9 | — | — | 20.0 | — |
| Optional Polyol 1 | 45.3 | 45.3 | 45.3 | 43.1 |
| Flame Retardant 1 | 20.0 | 20.0 | 20.0 | 20.0 |
| Surfactant 1 | 2.0 | 2.0 | 2.0 | 2.0 |
| Catalyst 1 | 0.6 | 0.6 | 0.6 | 0.6 |
| Catalyst 2 | 0.3 | 0.3 | 0.3 | 0.6 |
| Blowing Agent 1 | 1.8 | 1.8 | 1.8 | — |
| Blowing Agent 2 | 10.0 | 10.0 | 10.0 | 10.0 |
| Additive 1 | — | — | — | 4.0 |
| Total | 100.0 | 100.0 | 100.0 | 100.3 |
| Resin Eq. Wt. | 163.39 | 162.85 | 162.85 | 173.78 |
| Resin Sp. Gr. | 1.207 | 1.208 | 1.208 | 1.211 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | Livonia Mixer | Livonia Mixer | Spatula |
| Parameters | 2340 RPM | 2340 RPM | 2340 RPM | |
| Resin Wt. (g) | 85.2 | 85 | 88.21 | 28.7 |
| Iso. Wt. (g) | 87.9 | 87.55 | 90.86 | 29.53 |
| Hand Mix Ratio (g) | 103.17 | 103.00 | 103.00 | 102.89 |
| Isocyanate Index | 126.37 | 125.75 | 125.75 | 134.05 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 24 | Foam 25 | Foam 26 | Foam 27 |
| Resin Composition | | | | |
| Novolac Polyol 10 | 30.0 | 30.0 | 30.0 | 30.0 |
| Optional Polyol 1 | 35.6 | 35.6 | 30.6 | 30.6 |
| Flame Retardant 1 | 20.0 | 20.0 | 20.0 | 20.0 |
| Surfactant 1 | 2.0 | 2.0 | 2.0 | 2.0 |
| Catalyst 2 | 0.6 | 1.2 | 0.6 | 1.2 |
| Blowing Agent 1 | 1.8 | 1.8 | — | — |
| Blowing Agent 2 | 10.0 | 10.0 | 10.0 | 10.0 |
| Additive 1 | 0.35 | 0.69 | 4.0 | 4.0 |
| Additive 2 | — | — | 2.8 | 2.8 |
| Total | 100.35 | 101.29 | 100 | 100.6 |
| Resin Eq. Wt. | 147.58 | 145.75 | 162.54 | 162.54 |
| Resin Sp. Gr. | 1.204 | 1.201 | 1.210 | 1.210 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | Livonia Mixer | Livonia Mixer | Livonia Mixer | Livonia Mixer |
| Parameters | 2340 RPM | 2340 RPM | 3100 RPM | 3100 RPM |
| Resin Wt. (g) | 73.86 | 73.78 | 74.07 | 74.07 |
| Iso. Wt. (g) | 76.15 | 76.22 | 75.93 | 75.93 |
| Hand Mix Ratio (g) | 103.10 | 103.31 | 102.51 | 102.51 |
| Isocyanate Index | 114.07 | 112.88 | 124.91 | 124.91 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 28 | Foam 29 | Foam 30 | Foam 31 |
| Resin Composition | | | | |
| Novolac Polyol 10 | 27.9 | 27.7 | 20.5 | 20.5 |
| Optional Polyol 1 | 30.6 | 30.6 | 43.0 | 42.5 |
| Flame Retardant 1 | 18.6 | 18.6 | 24.5 | 20.2 |
| Surfactant 1 | 2.0 | 2.0 | 2.0 | 2.0 |
| Catalyst 1 | — | — | 2.0 | 3.0 |
| Catalyst 2 | 7.0 | 7.0 | — | — |
| Blowing Agent 1 | — | 1.8 | 2.1 | 2.1 |
| Blowing Agent 2 | 10.0 | 10.0 | 10.0 | 10.0 |
| Total | 96.1 | 97.7 | 104.1 | 100.3 |
| Resin Eq. Wt. | 168.3 | 129.1 | 153.65 | 153.35 |
| Resin Sp. Gr. | 1.177 | 1.178 | 1.203 | 1.202 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | Livonia Mixer | Livonia Mixer | Livonia Mixer | Livonia Mixer |
| Parameters | 3100 RPM | 3100 RPM | 3100 RPM | 3100 RPM |
| Resin Wt. (g) | 72.9 | 72.78 | 58.97 | 58.94 |
| Iso. Wt. (g) | 77.11 | 77.22 | 61.03 | 61.06 |
| Hand Mix Ratio (g) | 105.78 | 106.10 | 103.49 | 103.60 |
| Isocyanate Index | 133.46 | 101.96 | 119.21 | 119.10 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 32 | Foam 33 | Foam 34 | Foam 35 |
| Resin Composition | | | | |
| Novolac Polyol 10 | 20.0 | 25.0 | 25.0 | 30.0 |
| Optional Polyol 1 | 42.0 | 45.32 | — | — |
| Optional Polyol 2 | — | — | 45.3 | 40.3 |
| Flame Retardant 1 | 20.0 | 15.0 | 15.0 | 15.0 |
| Surfactant 1 | 2.0 | 2.0 | 2.0 | 2.0 |
| Catalyst 1 | 4.0 | 0.6 | 0.6 | 0.6 |
| Catalyst 2 | — | 0.3 | 0.3 | 0.3 |
| Blowing Agent 1 | 2.1 | 1.8 | 1.8 | 1.8 |
| Blowing Agent 2 | 10.0 | 10.0 | 10.0 | 10.0 |
| Total | 100.1 | 100.02 | 100.0 | 100.0 |
| Resin Eq. Wt. | 153.05 | 149.98 | 143.26 | 138.89 |
| Resin Sp. Gr. | 1.191 | 1.214 | 1.204 | 1.205 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.233 | 1.233 | 1.233 |
| Hand-Mix | Livonia Mixer | Livonia Mixer | Livonia Mixer | Livonia Mixer |
| Parameters | 3100 RPM | 3100 RPM | 3100 RPM | 3100 RPM |
| Resin Wt. (g) | 62.5 | 74.04 | 73.75 | 73.78 |
| Iso. Wt. (g) | 67.5 | 75.96 | 76.25 | 76.22 |
| Hand Mix Ratio (g) | 108.00 | 102.59 | 103.39 | 103.31 |
| Isocyanate Index | 123.92 | 115.34 | 111.04 | 107.57 |
| Properties of Foams | | | | |
| Friability | No | No | No | No |
| Intumescence | Yes | Yes | Yes | Yes |
| Butler Chimney | | | | |
| Percent Remaining | N/A | 93.97 | 94.30 | 94.29 |
| Extinguish Time (s) | N/A | 11 | 11 | 10 |
| Flame Height (cm) | N/A | 16 | 18 | 17 |
| | Foam 36 | Foam 37 | Foam 38 | Foam 39 |
| Resin Composition | | | | |
| Novolac Polyol 10 | 30.0 | — | 12.2 | 16.0 |
| Novolac Polyol 2 | — | 24.4 | — | — |
| Optional Polyol 1 | 31.5 | 37.1 | 37.1 | 34.3 |
| Flame Retardant 1 | 20. | 20.0 | 18.9 | 20.2 |
| Surfactant 1 | 2.0 | 2.0 | 2.0 | 2.0 |
| Catalyst 1 | 4.0 | 4.0 | 4.0 | 4.0 |
| Blowing Agent 1 | 2.5 | 2.5 | 2.5 | 2.5 |
| Blowing Agent 2 | 10.0 | 10.0 | 10.0 | 10.0 |
| Additive 3 | — | — | 13.3 | 12.2 |
| Total | 100.0 | 100.0 | 100.0 | 101.2 |
| Resin Eq. Wt. | 132.05 | 138.5 | 137.51 | 136.9 |
| Resin Sp. Gr. | 1.196 | 1.199 | 1.191 | 1.189 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 3100 RPM | 3100 RPM | 3100 RPM | 3100 RPM |
| Resin Wt. (g) | 73.86 | 73.96 | 73.71 | 73.64 |
| Iso. Wt. (g) | 76.14 | 76.04 | 76.29 | 76.36 |
| Hand Mix Ratio (g) | 103.09 | 102.81 | 103.50 | 103.69 |
| Isocyanate Index | 102.05 | 106.75 | 106.70 | 106.42 |
| Properties of Foams | | | | |
| Friability | No | No | No | No |
| Intumescence | Yes | Yes | Yes | Yes |
| Butler Chimney | | | | |
| Percent Remaining | 89.87 | N/A | 90.64 | 87.16 |
| Extinguish Time (s) | 10.67 | N/A | 10.33 | 10 |
| Flame Height (cm) | 20.3 | N/A | 22.0 | >25.0 |
| | Foam 40 | Foam 41 | Foam 42 | Foam 43 |
| Resin Composition | | | | |
| Novolac Polyol 10 | 7.5 | 22.5 | 12.5 | 30.0 |
| Optional Polyol 1 | 35.7 | 32.9 | 31.5 | 21.5 |
| Optional Polyol 3 | — | — | — | 10.0 |
| Flame Retardant 1 | 20.0 | 20.0 | 20.0 | 20.0 |
| Surfactant 1 | 2.0 | 2.0 | 2.0 | 2.0 |
| Catalyst 1 | 4.0 | 4.0 | 4.0 | 4.0 |
| Blowing Agent 1 | 2.5 | 2.5 | 2.5 | 2.5 |
| Blowing Agent 2 | 10.0 | 10.0 | 10.0 | 10.0 |
| Additive 3 | 18.3 | 6.1 | 17.5 | — |
| Total | 100 | 100 | 100 | 100 |
| Resin Eq. Wt. | 139.47 | 134.43 | 135.32 | 131.58 |
| Resin Sp. Gr. | 1.186 | 1.193 | 1.186 | 1.182 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 3100 RPM | 3100 RPM | 3100 RPM | 3100 RPM |
| Resin Wt. (g) | 73.53 | 73.75 | 73.57 | 73.42 |
| Iso. Wt. (g) | 76.47 | 76.25 | 76.43 | 76.58 |
| Hand Mix Ratio (g) | 104.00 | 103.39 | 103.89 | 104.30 |
| Isocyanate Index | 108.74 | 104.20 | 105.39 | 102.89 |
| Properties of Foams | | | | |
| Friability | No | No | No | No |
| Intumescence | Yes | Yes | Yes | Yes |
| Butler Chimney | | | | |
| Percent Remaining | 89.01 | 90.52 | 86.29 | N/A |
| Extinguish Time (s) | 10.33 | 10.33 | 10.00 | N/A |
| Flame Height (cm) | >25.0 | >25.0 | >25.0 | N/A |
| | Foam 44 | Foam 45 | Foam 46 | Foam 47 |
| Resin Composition | | | | |
| Novolac Polyol 10 | 20.0 | 20.0 | 24.5 | 30.0 |
| Optional Polyol 1 | 31.5 | 41.5 | — | 31.5 |
| Optional Polyol 3 | 10.0 | — | — | — |
| Flame Retardant 1 | 20.0 | 20.0 | 32.6 | 20.0 |
| Surfactant 1 | 2.0 | 2.0 | 2.0 | 2.0 |
| Catalyst 1 | 4.0 | 4.0 | 4.0 | 4.0 |
| Blowing Agent 1 | 2.5 | 2.5 | 2.5 | 2.5 |
| Blowing Agent 2 | 10.0 | 10.0 | 10.0 | 10.0 |
| Additive 3 | — | — | 24.5 | — |
| Total | 100 | 100 | 100.1 | 100 |
| Resin Eq. Wt. | 141.01 | 141.54 | 130.16 | 132.05 |
| Resin Sp. Gr. | 1.181 | 1.196 | 1.160 | 1.196 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 3100 RPM | 3100 RPM | 3100 RPM | 3100 RPM |
| Resin Wt. (g) | 73.39 | 73.86 | 72.71 | 73.86 |
| Iso. Wt. (g) | 76.61 | 76.14 | 77.29 | 76.14 |
| Hand Mix Ratio (g) | 104.39 | 103.09 | 106.30 | 103.09 |
| Isocyanate Index | 110.35 | 109.39 | 103.72 | 102.05 |
| Properties of Foams | | | | |
| Friability | No | No | No | No |
| Intumescence | Yes | Yes | Yes | Yes |
| Butler Chimney | | | | |
| Percent Remaining | 83.14 | 91.32 | 86.62 | 89.87 |
| Extinguish Time (s) | 10.33 | 10 | 10.3 | 10.67 |
| Flame Height (cm) | >25 | >25 | >25 | 20.3 |
| | Foam 48 | Foam 49 | Foam 50 | Foam 51 |
| Resin Composition | | | | |
| Novolac Polyol 10 | 15.0 | 7.5 | 22.5 | 20.0 |
| Optional Polyol 1 | 34.3 | 35.7 | 32.9 | 31.5 |
| Optional Polyol 3 | — | — | — | 10.0 |
| Flame Retardant 1 | 20.0 | 20.0 | 20.0 | 20.0 |
| Surfactant 1 | 2.0 | 2.0 | 2.0 | 2.0 |
| Catalyst 1 | 4.0 | 4.0 | 4.0 | 4.0 |
| Blowing Agent 1 | 2.5 | 2.5 | 2.5 | 2.5 |
| Blowing Agent 2 | 10.0 | 10.0 | 10.0 | 10.0 |
| Additive 3 | 12.2 | 18.3 | 8.1 | — |
| Total | 100.0 | 100.0 | 102.0 | 100.0 |
| Resin Eq. Wt. | 138.9 | 139.47 | 134.43 | 141.01 |
| Resin Sp. Gr. | 1.189 | 1.158 | 1.193 | 1.181 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 3100 RPM | 3100 RPM | 3100 RPM | 2340 RPM |
| Resin Wt. (g) | 73.64 | 73.53 | 73.76 | 73.39 |
| Iso. Wt. (g) | 76.36 | 76.47 | 76.25 | 76.61 |
| Hand Mix Ratio (g) | 103.69 | 104.00 | 103.39 | 104.39 |
| Isocyanate Index | 106.42 | 108.74 | 104.20 | 110.35 |
| Properties of Foams | | | | |
| Friability | No | No | No | No |
| Intumescence | Yes | Yes | Yes | Yes |
| Butler Chimney | | | | |
| Percent Remaining | 87.16 | 89.01 | 90.52 | 83.14 |
| Extinguish Time (s) | 10.00 | 10.33 | 10.33 | 10.33 |
| Flame Height (cm) | >25.0 | >25.0 | >25.0 | >25.0 |
| | Foam 52 | Foam 53 | Foam 54 | Foam 55 |
| Resin Composition | | | | |
| Novolac Polyol 10 | 20.0 | 24.5 | 22.5 | 45.0 |
| Optional Polyol 1 | 41.5 | — | 44.0 | 6.5 |
| Flame Retardant 1 | 20.0 | 32.6 | 15.0 | 30.0 |
| Surfactant 1 | 2.0 | 2.0 | 2.0 | 2.0 |
| Catalyst 1 | 4.0 | 4.0 | 4.0 | 4.0 |
| Blowing Agent 1 | 2.5 | 2.5 | 2.5 | 2.5 |
| Blowing Agent 2 | 10.0 | 10.0 | 10.0 | 10.0 |
| Additive 3 | — | 24.5 | — | — |
| Total | 100 | 100.1 | 100 | 100 |
| Resin Eq. Wt. | 141.54 | 130.16 | 134.62 | 127.18 |
| Resin Sp. Gr. | 1.196 | 1.160 | 1.206 | 1.178 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 2340 RPM | 2340 RPM | 2340 RPM | 2340 RPM |
| Resin Wt. (g) | 73.86 | 72.71 | 74.15 | 73.31 |
| Iso. Wt. (g) | 76.14 | 77.29 | 75.85 | 76.69 |
| Hand Mix Ratio (g) | 103.09 | 106.30 | 102.29 | 104.61 |
| Isocyanate Index | 109.39 | 103.72 | 103.24 | 99.74 |
| Properties of Foams | | | | |
| Friability | No | No | No | No |
| Intumescence | Yes | Yes | Yes | Yes |
| Butler Chimney | | | | |
| Percent Remaining | 91.32 | N/A | 86.62 | 88.98 |
| Extinguish Time (s) | 10.00 | N/A | 10.30 | 10.30 |
| Flame Height (cm) | >25.0 | N/A | >25.0 | >25.0 |

| | Foam 56 | Foam 57 | Foam 58 |
|---|---|---|---|
| Resin Composition | | | |
| Novolac Polyol 10 | 15.0 | 30.0 | 30.6 |
| Optional Polyol 1 | 61.0 | 31.5 | 32.2 |
| Flame Retardant 1 | 10.0 | 20.0 | 20.4 |
| Surfactant 1 | 2.0 | 2.0 | 2.0 |
| Catalyst 1 | 4.0 | 4.0 | — |
| Catalyst 3 | — | — | 2.0 |
| Blowing Agent 1 | 2.0 | 2.5 | 2.6 |
| Blowing Agent 2 | 10.0 | 10.0 | 10.0 |
| Total | 104 | 100 | 99.8 |
| Resin Eq. Wt. | 149.55 | 132.05 | 132.94 |
| Resin Sp. Gr. | 1.218 | 1.196 | 1.196 |
| Isocyanate | Isocyanate 2 | Isocyanate 2 | Isocyanate 2 |
| Composition | | | |
| Iso. Equiv. Wt. | 133.4 | 133.4 | 133.4 |
| Iso Sp. Gr. | 1.233 | 1.245 | 1.245 |
| Hand-Mix | German Mixer | German Mixer | German Mixer |
| Parameters | 2340 RPM | 2340 RPM | 2340 RPM |
| Resin Wt. (g) | 74.62 | 73.88 | 73.86 |
| Iso. Wt. (g) | 75.48 | 76.14 | 76.14 |
| Hand Mix Ratio (g) | 101.29 | 103.0 | 103.09 |
| Isocyanate Index | 113.79 | 102.05 | 102.74 |
| Properties of Foams | | | |
| Friability | No | No | No |
| Intumescence | Yes | Yes | Yes |
| Butler Chimney | | | |
| Percent Remaining | N/A | N/A | N/A |
| Extinguish Time (s) | N/A | N/A | N/A |
| Flame Height (cm) | N/A | N/A | N/A |

| | Foam 59 | Foam 60 | Foam 61 | Foam 62 |
|---|---|---|---|---|
| Resin Composition | | | | |
| Novolac Polyol 10 | 30.0 | 29.4 | 30.3 | 30.6 |
| Optional Polyol 1 | 31.5 | 30.8 | 32.8 | 32.2 |
| Flame Retardant 1 | 20.0 | 19.6 | 20.2 | 20.4 |
| Surfactant 1 | 2.0 | 2.0 | 2.0 | 2.0 |
| Catalyst 1 | — | 4.0 | 2.0 | — |
| Catalyst 3 | 4.0 | 2.0 | 1.0 | — |
| Catalyst 4 | — | — | — | 2.0 |
| Blowing Agent 1 | 2.0 | 2.5 | 2.5 | 2.6 |
| Blowing Agent 2 | 10.0 | 9.8 | 10.1 | 10.2 |
| Total | 99.5 | 100.1 | 100.9 | 100 |
| Resin Eq. Wt. | 133.16 | 132.27 | 132.49 | 135.42 |
| Resin Sp. Gr. | 1.188 | 1.189 | 1.196 | 1.194 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | German Mixer | German Mixer | German Mixer |
| Parameters | 2340 RPM | 2340 RPM | 2340 RPM | 2340 RPM |
| Resin Wt. (g) | 73.6 | 7.064 | 73.86 | 73.78 |
| Iso. Wt. (g) | 76.4 | 78.36 | 76.15 | 76.22 |
| Hand Mix Ratio (g) | 103.80 | 103.69 | 103.10 | 103.31 |
| Isocyanate Index | 103.63 | 102.82 | 102.40 | 104.88 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 63 | Foam 64 | Foam 65 | Foam 66 |
| Resin Composition | | | | |
| Novolac Polyol 10 | 30.6 | 30.6 | 30.6 | 30.0 |
| Optional Polyol 1 | 32.2 | 32.2 | 32.2 | 31.5 |
| Flame Retardant 1 | 20.4 | 20.4 | 20.4 | 20.0 |
| Surfactant 1 | 2.0 | 2.0 | 2.0 | 2.0 |
| Catalyst 1 | — | — | — | 2.0 |
| Catalyst 2 | 2.0 | — | — | — |
| Catalyst 3 | — | — | 2.0 | 2.0 |
| Catalyst 4 | — | — | — | — |
| Catalyst 5 | — | 2.0 | — | — |
| Blowing Agent 1 | 2.6 | 2.6 | 2.6 | 2.5 |
| Blowing Agent 2 | 10.2 | 10.2 | 10.2 | 10.0 |
| Total | 100 | 100 | 100 | 100 |
| Resin Eq. Wt. | 135.42 | 132.46 | 132.94 | 132.6 |
| Resin Sp. Gr. | 1.194 | 1.200 | 1.196 | 1.192 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | German Mixer | German Mixer | German Mixer |
| Parameters | 2340 RPM | 2340 RPM | 2340 RPM | 2340 RPM |
| Resin Wt. (g) | 73.78 | 74 | 73.86 | 73.75 |
| Iso. Wt. (g) | 76.22 | 76 | 78.14 | 76.25 |
| Hand Mix Ratio (g) | 103.31 | 102.70 | 103.09 | 103.39 |
| Isocyanate Index | 104.86 | 101.99 | 102.74 | 102.78 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |

| | Foam 67 | Foam 68 | Foam 69 |
|---|---|---|---|
| Resin Composition | | | |
| Novolac Polyol 10 | 14.4 | 14.7 | 14.7 |
| Optional Polyol 1 | 58.6 | 59.8 | 59.8 |
| Flame Retardant 1 | 9.6 | 9.8 | 9.8 |
| Surfactant 1 | 1.9 | 2.0 | 2.0 |
| Catalyst 1 | 4.0 | — | — |
| Catalyst 3 | — | 2.0 | — |
| Catalyst 4 | — | — | 2.0 |
| Blowing Agent 1 | 1.9 | 2.0 | 2.0 |
| Blowing Agent 2 | 9.6 | 9.8 | 9.8 |
| Total | 100 | 100.1 | 100.1 |
| Resin Eq. Wt. | 149.78 | 151.36 | 154.58 |
| Resin Sp. Gr. | 1.217 | 1.217 | 1.215 |
| Isocyanate | Isocyanate 2 | Isocyanate 2 | Isocyanate 2 |
| Composition | | | |
| Iso. Equiv. Wt. | 133.4 | 133.4 | 133.4 |
| Iso Sp. Gr. | 1.245 | 1.245 | 1.245 |
| Hand-Mix Parameters | German Mixer | German Mixer | German Mixer |
| | 2340 RPM | 2340 RPM | 2340 RPM |
| Resin Wt. (g) | 74.52 | 74.52 | 74.44 |
| Iso. Wt. (g) | 75.48 | 75.48 | 75.56 |
| Hand Mix Ratio (g) | 101.29 | 101.29 | 101.50 |
| Isocyanate Index | 113.73 | 114.93 | 117.63 |
| Properties of Foams | | | |
| Friability | No | No | No |
| Intumescence | Yes | Yes | Yes |
| Butler Chimney | | | |
| Percent Remaining | N/A | N/A | N/A |
| Extinguish Time (s) | N/A | N/A | N/A |
| Flame Height (cm) | N/A | N/A | N/A |

| | Foam 70 | Foam 71 | Foam 72 | Foam 73 |
|---|---|---|---|---|
| Resin Composition | | | | |
| Novolac Polyol 10 | 14.7 | 14.7 | 14.4 | 14.4 |
| Optional Polyol 1 | 59.8 | 59.8 | 58.6 | 58.6 |
| Flame Retardant 1 | 9.8 | 9.8 | 9.6 | 9.6 |
| Surfactant 1 | — | — | 2.0 | — |
| Catalyst 1 | — | — | 2.0 | — |
| Catalyst 3 | — | — | 2.0 | — |
| Catalyst 4 | — | — | — | 2.0 |
| Catalyst 6 | — | 2.0 | — | — |
| Blowing Agent 1 | 2.9 | 2.0 | 1.9 | 1.9 |
| Blowing Agent 2 | 9.8 | 9.8 | 9.6 | 9.6 |
| Total | 97 | 98.1 | 100.1 | 96.1 |
| Resin Eq. Wt. | 154.58 | 154.58 | 150.49 | 153.68 |
| Resin Sp. Gr. | 1.215 | 1.217 | 1.213 | 1.211 |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | German Mixer | German Mixer | German Mixer |
| Parameters | 2340 RPM | 2340 RPM | 2340 RPM | 2340 RPM |
| Resin Wt. (g) | 74.44 | 74.52 | 72.5 | 74.33 |
| Iso. Wt. (g) | 75.56 | 75.48 | 74 | 75.67 |
| Hand Mix Ratio (g) | 101.50 | 101.29 | 102.07 | 101.80 |
| Isocyanate Index | 117.63 | 117.38 | 115.15 | 117.29 |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 74 | Foam 75 | Foam 76 | Foam 77 |
| Resin Composition | | | | |
| Novolac Polyol 1 | — | — | 60 | — |
| Novolac Polyol 2 | — | — | — | 60 |
| Novolac Polyol 10 | 14.4 | 14.4 | — | — |
| Optional Polyol 1 | 58.6 | 58.6 | 12.98 | 12.98 |
| Flame Retardant 1 | 9.6 | 9.6 | 9.6 | 9.6 |
| Surfactant 1 | 1.9 | 1.92 | 1.92 | 1.92 |
| Catalyst 1 | 2.0 | — | 2.0 | 2.0 |
| Catalyst 2 | 2.0 | — | 2.0 | 2.0 |
| Catalyst 3 | — | 2.0 | — | — |
| Catalyst 6 | — | 2.0 | — | — |
| Blowing Agent 1 | 1.9 | 1.9 | 1.9 | 1.9 |
| Blowing Agent 2 | 9.6 | 9.6 | 9.6 | 9.6 |
| Total | 100 | 100.02 | 100.00 | 100.00 |
| Resin Eq. Wt. | 153.66 | 154.14 | N/A | N/A |
| Resin Sp. Gr. | 1.211 | 1.209 | N/A | N/A |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | German Mixer | German Mixer | German Mixer |
| Parameters | 2340 RPM | 2340 RPM | 2340 RPM | 2340 RPM |
| Resin Wt. (g) | 74.33 | 74.26 | N/A | N/A |
| Iso. Wt. (g) | 75.67 | 75.67 | N/A | N/A |
| Hand Mix Ratio (g) | 101.80 | 101.99 | N/A | N/A |
| Isocyanate Index | 117.29 | 117.86 | N/A | N/A |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 78 | Foam 79 | Foam 80 | Foam 81 |
| Resin Composition | | | | |
| Novolac Polyol 3 | 60 | — | — | — |
| Novolac Polyol 4 | — | 60 | — | — |
| Novolac Polyol 5 | — | — | 60 | 60 |
| Novolac Polyol 6 | — | — | — | — |
| Optional Polyol 1 | 12.98 | 12.98 | 12.98 | 12.98 |
| Flame Retardant 1 | 9.6 | 9.6 | 9.6 | 9.6 |
| Surfactant 1 | 1.92 | 1.92 | 1.92 | 1.92 |
| Catalyst 1 | 2.0 | 2.0 | 2.0 | 2.0 |
| Catalyst 2 | 2.0 | 2.0 | 2.0 | 2.0 |
| Blowing Agent 1 | 1.9 | 1.9 | 1.9 | 1.9 |
| Blowing Agent 2 | 9.6 | 9.6 | 9.6 | 9.6 |
| Total | 100.00 | 100.00 | 100.00 | 100.00 |
| Resin Eq. Wt. | N/A | N/A | N/A | N/A |
| Resin Sp. Gr. | N/A | N/A | N/A | N/A |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | German Mixer | German Mixer | German Mixer |
| Parameters | 2340 RPM | 2340 RPM | 2340 RPM | 2340 RPM |
| Resin Wt. (g) | N/A | N/A | N/A | N/A |
| Iso. Wt. (g) | N/A | N/A | N/A | N/A |
| Hand Mix Ratio (g) | N/A | N/A | N/A | N/A |
| Isocyanate Index | N/A | N/A | N/A | N/A |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Foam 82 | Foam 83 | Foam 84 | Foam 85 |
| Resin Composition | | | | |
| Novolac Polyol 7 | 60 | — | — | — |
| Novolac Polyol 8 | — | 60 | — | — |
| Novolac Polyol 9 | — | — | 60 | 60 |
| Novolac Polyol 10 | — | — | — | — |
| Optional Polyol 1 | 12.98 | 12.98 | 12.98 | 12.98 |
| Flame Retardant 1 | 9.6 | 9.6 | 9.6 | 9.6 |
| Surfactant 1 | 1.92 | 1.92 | 1.92 | 1.92 |
| Catalyst 1 | 2.0 | 2.0 | 2.0 | 2.0 |
| Catalyst 2 | 2.0 | 2.0 | 2.0 | 2.0 |
| Blowing Agent 1 | 1.9 | 1.9 | 1.9 | 1.9 |
| Blowing Agent 2 | 9.6 | 9.6 | 9.6 | 9.6 |
| Total | 100.00 | 100.00 | 100.00 | 100.00 |
| Resin Eq. Wt. | N/A | N/A | N/A | N/A |
| Resin Sp. Gr. | N/A | N/A | N/A | N/A |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.245 | 1.245 | 1.245 | 1.245 |
| Hand-Mix | German Mixer | German Mixer | German Mixer | German Mixer |
| Parameters | 2340 RPM | 2340 RPM | 2340 RPM | 2340 RPM |
| Resin Wt. (g) | N/A | N/A | N/A | N/A |
| Iso. Wt. (g) | N/A | N/A | N/A | N/A |
| Hand Mix Ratio (g) | N/A | N/A | N/A | N/A |
| Isocyanate Index | N/A | N/A | N/A | N/A |
| Properties of Foams | | | | |
| Friability | No | No | No | No |
| Intumescence | Yes | Yes | Yes | Yes |
| Butler Chimney | | | | |
| Percent Remaining | N/A | N/A | N/A | N/A |
| Extinguish Time (s) | N/A | N/A | N/A | N/A |
| Flame Height (cm) | N/A | N/A | N/A | N/A |
| | Comparative | Comparative | Comparative | Comparative |
| | Foam 1 | Foam 2 | Foam 3 | Foam 4 |
| Resin Composition | | | | |
| Optional Polyol 1 | — | 37.1 | — | — |
| Optional Polyol 2 | 37.1 | — | — | — |
| Novolac Polyol 1 | — | — | 70 | — |
| Novolac Polyol 2 | — | — | — | 70 |
| Flame | 24.4 | 20.0 | 12.58 | 12.58 |
| Retardant 1 | | | | |
| Surfactant 1 | 2.0 | — | 1.92 | 1.92 |
| Catalyst 1 | 4.0 | 4.0 | 2.0 | 2.0 |
| Catalyst 2 | — | — | 2.0 | 2.0 |
| Catalyst 3 | — | 2.0 | — | — |
| Catalyst 6 | — | — | — | — |
| Additive 3 | — | 24.4 | — | — |
| Blowing Agent 1 | 2.5 | 2.5 | 1.9 | 1.9 |
| Blowing Agent 2 | 10.0 | 10.0 | 9.6 | 9.6 |
| Total | 80 | 100 | 100.0 | 100.0 |
| Resin Eq. Wt. | 142.13 | 142.13 | N/A | N/A |
| Resin Sp. Gr. | 1.185 | 1.182 | N/A | N/A |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 2340 RPM | 2340 RPM | 2340 RPM | 2340 RPM |
| Resin Wt. (g) | 73.42 | 73.56 | N/A | N/A |
| Iso. Wt. (g) | 76.58 | 76.14 | N/A | N/A |
| Hand Mix Ratio (g) | 104.30 | 103.09 | N/A | N/A |
| Isocyanate Index | 111.14 | 102.05 | N/A | N/A |
| Properties of Foams | | | | |
| Friability | No | No | N/A* | N/A* |
| Intumescence | No | No | N/A* | N/A* |
| Butler Chimney | | | | |
| Percent | 90.64 | 88.09 | N/A* | N/A* |
| Remaining | | | | |
| Extinguish | 10.33 | 10.67 | N/A* | N/A* |
| Time (s) | | | | |
| Flame Height | 22.0 | >25.0 | N/A* | N/A* |
| (cm) | | | | |
| | Comparative | Comparative | Comparative | Comparative |
| | Foam 5 | Foam 6 | Foam 7 | Foam 8 |
| Resin Composition | | | | |
| Novolac Polyol 3 | 70 | — | — | — |
| Novolac Polyol 4 | — | 70 | — | — |
| Novolac Polyol 5 | — | — | 70 | — |
| Novolac Polyol 6 | — | — | — | 70 |
| Flame | 12.58 | 12.58 | 12.58 | 12.58 |
| Retardant 1 | | | | |
| Surfactant 1 | 1.92 | 1.92 | 1.92 | 1.92 |
| Catalyst 1 | 2.0 | 2.0 | 2.0 | 2.0 |
| Catalyst 2 | 2.0 | 2.0 | 2.0 | 2.0 |
| Blowing Agent 1 | 1.9 | 1.9 | 1.9 | 1.9 |
| Blowing Agent 2 | 9.6 | 9.6 | 9.6 | 9.6 |
| Total | 100.0 | 100.0 | 100.0 | 100.0 |
| Resin Eq. Wt. | N/A | N/A | N/A | N/A |
| Resin Sp. Gr. | N/A | N/A | N/A | N/A |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 2340 RPM | 2340 RPM | 2340 RPM | 2340 RPM |
| Resin Wt. (g) | N/A | N/A | N/A | N/A |
| Iso. Wt. (g) | N/A | N/A | N/A | N/A |
| Hand Mix Ratio (g) | N/A | N/A | N/A | N/A |
| Isocyanate | N/A | N/A | N/A | N/A |
| Index | | | | |
| Properties of Foams | | | | |
| Friability | N/A* | N/A* | N/A* | N/A* |
| Intumescence | N/A* | N/A* | N/A* | N/A* |
| Butler Chimney | | | | |
| Percent | N/A* | N/A* | N/A* | N/A* |
| Remaining | | | | |
| Extinguish | N/A* | N/A* | N/A* | N/A* |
| Time (s) | | | | |
| Flame Height (cm) | N/A* | N/A* | N/A* | N/A* |
| | Comparative | Comparative | Comparative | Comparative |
| | Foam 9 | Foam 10 | Foam 11 | Foam 12 |
| Resin Composition | | | | |
| Novolac Polyol 7 | 70 | — | — | — |
| Novolac Polyol 8 | — | 70 | — | — |
| Novolac Polyol 9 | — | — | 70 | — |
| Novolac Polyol 10 | — | — | — | 70 |
| Flame | 12.58 | 12.58 | 12.58 | 12.58 |
| Retardant 1 | | | | |
| Surfactant 1 | 1.92 | 1.92 | 1.92 | 1.92 |
| Catalyst 1 | 2.0 | 2.0 | 2.0 | 2.0 |
| Catalyst 2 | 2.0 | 2.0 | 2.0 | 2.0 |
| Blowing Agent 1 | 1.9 | 1.9 | 1.9 | 1.9 |
| Blowing Agent 2 | 9.6 | 9.6 | 9.6 | 9.6 |
| Total | 100.0 | 100.0 | 100.0 | 100.0 |
| Resin Eq. Wt. | N/A | N/A | N/A | N/A |
| Resin Sp. Gr. | N/A | N/A | N/A | N/A |
| Isocyanate | Isocyanate 2 | Isocyanate 2 | Isocyanate 2 | Isocyanate 2 |
| Composition | | | | |
| Iso. Equiv. Wt. | 133.4 | 133.4 | 133.4 | 133.4 |
| Iso Sp. Gr. | 1.233 | 1.233 | 1.233 | 1.233 |
| Hand-Mix | German Mixer | German Mixer | German Mixer | German Mixer |
| Parameters | 2340 RPM | 2340 RPM | 2340 RPM | 2340 RPM |
| Resin Wt. (g) | N/A | N/A | N/A | N/A |
| Iso. Wt. (g) | N/A | N/A | N/A | N/A |
| Hand Mix Ratio (g) | N/A | N/A | N/A | N/A |
| Isocyanate Index | N/A | N/A | N/A | N/A |
| Properties of Foams | | | | |
| Friability | N/A* | N/A* | N/A* | N/A* |
| Intumescence | N/A* | N/A* | N/A* | N/A* |
| Butler Chimney | | | | |
| Percent | N/A* | N/A* | N/A* | N/A* |
| Remaining | | | | |
| Extinguish | N/A* | N/A* | N/A* | N/A* |
| Time (s) | | | | |
| Flame Height | N/A* | N/A* | N/A* | N/A* |
| (cm) | | | | |

*N/A = Resin Composition is too viscous to be used to form a foam

Novolac Polyol 1 is commercially available under the trade name of Durite E SD-2637-85.

Novolac Polyol 2 is commercially available under the trade name of Durite SD-1731.

Novolac Polyol 3 is commercially available under the trade name of GP 5300.

Novolac Polyol 4 is commercially available under the trade name of GPR CK-0036.

Novolac Polyol 5 is commercially available under the trade name of GPR CK-2103.

Novolac Polyol 6 is commercially available under the trade name of GPR CK-2500.

Novolac Polyol 7 is commercially available under the trade name of GPR CK-2400.

Novolac Polyol 8 is commercially available under the trade name of GP2056.

Novolac Polyol 9 is commercially available under the trade name of GP5555.

Novolac Polyol 10 is commercially available under the trade name of Durite 1713.

Optional Polyol 1 is commercially available under the trade name of Terol 258.

Optional Polyol 2 is commercially available under the trade name of Terol 305.

Optional Polyol 3 is commercially available under the trade name of Carpol GSP-280.

Flame Retardant 1 is triethylphosphate.

Surfactant 1 is commercially available under the trade name of DC 193.

Catalyst 1 is commercially available under the trade name of DABCO BL-17.

Catalyst 2 is commercially available under the trade name of DABCO BL-19.

Catalyst 3 is commercially available under the trade name of DABCO T.

Catalyst 4 is commercially available under the trade name of Polycat 5.

Catalyst 5 is commercially available under the trade name of DABCO TMR.

Catalyst 6 is commercially available under the trade name of DABCO BDMA.

Blowing Agent 1 is water.

Blowing Agent 2 is commercially available under the trade name of HFC 245fa.

Additive 1 is formic acid.

Additive 2 is hexamethylene tetramine.

Additive 3 is bisphenol A.

Isocyanate 1 is commercially available under the trade name of ISO 277.

Isocyanate 2 is commercially available under the trade name of Lupranate M20.

Formation of the Comparative Foams 3-12 is attempted using 70 parts by weight of the novolac polyol, but this weight amount does not allow a suitable foam to form due to excessive viscosity of the resin composition. In one embodiment, the upper limit of the viscosity of the novolac polyol is about 10,000-10,500 cps at 25° C. Above this viscosity, the resin composition tends to be too viscose to process. The table below summarizes the approximate viscosity of various novolac polyols dissolved in varying weight percents in triethylphosphate (TEP) at 25° C. The viscosity is directly related to the average molecular weight of the novolac polyol. In one embodiment, the highest practical concentration of novolac polyol in TEP is about 60%. Since TEP has a viscosity of only 1.6 cps at 25° C., it may be the lowest viscosity flame retardant/diluent that is suitable such that 60 parts by weight of the novolac polyol tends to be about the highest concentration that can practically be used.

| | 50% | 55% | 60% | 70% |
|---|---|---|---|---|
| Novolac Polyol | Novolac | Novolac | Novolac | Novolac |
| Commercial | Polyol | Polyol | Polyol | Polyol |
| Names | in TEP | in TEP | in TEP | in TEP |
| Durite E | 954 | — | 8,150 | 158,000 |
| SD-2637-85 | | | | |
| Durite SD- | 5,760 | 21,500 | 129,000 | — |
| 1731 | | | | |
| GP 5300 | 1,090 | 4,940 | 22,800 | — |
| GPRI CK-0036 | 445 | — | 6,800 | — |
| GP 2056 | 7,950 | — | — | — |
| GP 5555 | 10,600 | — | — | — |
| GPRI CK-2103 | 726 | — | 17,700 | — |
| GPRI CK-2500 | 1,140 | — | 33,000 | — |
| GPRI 651G53 | 20,500 | — | — | — |
| GPRI CK-2400 | 6,650 | — | — | — |
| Durite D | — | — | 10,200 | — |
| SD-1713 | | | | |
| Bisphenol A | 218 | Crystals | Crystals | — |
| Durite SD357B | 8,800 | — | — | — |

### Additional Rigid Polyurethane Foams:

An additional rigid polyurethane foam (Foam 86) is also formed along with an additional comparative rigid polyurethane foam (Comparative Foam 13). The Comparative Foam 13 is not formed using any novolac polyol of this invention. After formation, the Foam 86 and the Comparative Foam 13 are evaluated to determine average Flame Spread Value (FSV) and average Smoke Developed Value (SDV) according to CAN/ULC-S102 tunnel burn. Relative to Foam 86, 3 total samples are used to generate the averages. Comparative Foam 13 is only burned once. During the burn, the foam falls towards the end of the test thus not allowing an accurate smoke value to be generated. The formulations of Foam 86 and Comparative Foam 13, along with the FSVs and SDVs, are set forth below in Table 3.

TABLE 3

| | Comparative | |
|---|---|---|
| | Foam 13 | Foam 86 |
| Polyol Component | 55.3 | 49.9 |
| Flame Retardant Component | 20.0 | 20.0 |
| Surfactant Component | 2.5 | 4.0 |
| Catalyst Component | 2.9 | 1.9 |
| Physical Blowing Agent Component | 18.0 | 18.0 |
| Water | 1.3 | 1.2 |
| Phenolic Resin Component | 0 | 5.0 |
| FSV (Red Oak = 100) | ~469 | ~315 |
| SDV | >200* | ~490 |

*Comparative Foam 13 is only burned once. During the burn, the foam falls towards the end of the test thus not allowing an accurate smoke value to be generated.

The Polyol Component includes two amine polyols and a polyester polyol.

The Flame Retardant Component includes a phosphate flame retardant.

The Surfactant Component includes an organic surfactant and a silicone surfactant.

The Catalyst Component includes a metal catalyst.

The Physical Blowing Agent Component includes a fluorinated blowing agent and an organic blowing agent.

The Phenol Resin Component includes a novolac polyol of this invention.

The data set forth in the Tables above suggests that the rigid polyurethane foams of the instant invention generally intumesce (i.e., swell) and char and have decreased scorch and flammability and therefore can be used to replaced or partially replace other flame retardants. The novolac polyol typically acts as an antioxidant and is thought to interfere with chemical reactions associated with burning and charring of the rigid polyurethane foam. The novolac polyol also typically reacts with isocyanates more quickly than the isocyanates react with water thereby increasing production speed, reducing cost, and allowing the rigid polyurethane foam of this invention to be used in a wide variety of applications, especially those that require fast foaming times. The data in Table 3 also suggests that the rigid polyurethane foam is superior to a comparative foam formed without the novolac polyol of this invention relative to FSV and SDV. Accordingly, the instant invention produces special and unexpected results at least relative to use of the claimed range of the novolac polyol.

Foam 86 and an additional foam (Foam 87) are also formed and visually evaluated to determine the quantitative amount of yellowing and/or scorching when applied in a single pass application. Each formulation is spray applied to approximately fill a 16″×16″×16″ box. The formulations of Foam 86 and 87, along with evaluations of yellowing and/or scorching are set forth below in Table 4.

TABLE 4

| | Foam 86 | Foam 87 |
|---|---|---|
| Polyol Component | 49.9 | 44.9 |
| Flame Retardant Component | 20 | 20 |
| Surfactant Component | 4 | 4 |
| Catalyst Component | 1.9 | 1.9 |
| Physical Blowing Agent Component | 18 | 18 |
| Water | 1.2 | 1.2 |
| Phenolic Resin Component | 5.0 | 10.0 |
| Total Thickness before Yellowing/Scorching | ~6 in | ~9 in |
| Core Yellowing/Scorching | ~1000 in³ | ~275 in³ |
| Total Spray Area | ~3600 in³ | ~3500 in³ |
| Core Density (lb/ft³) | 1.90 | 1.94 |

Each of the components set forth in Table 4 is as described above.

The data set forth in the above table suggests that increasing quantities of the novolac polyol reduces a total quantity of yellowing or scorching in spray polyurethane foams. The inclusion of the novolac polyol appears to produce less heat and trends indicate that increasing quantities allows for thicker foam applications before signs of scorching. This data provides additional support for the special and unexpected results produced by this invention.

It is to be understood that one or more of the values described above may vary by ±5%, ±10%, ±15%, ±20%, ±25%, ±30%, etc. so long as the variance remains within the scope of the invention. It is also to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The subject matter of all combinations of independent and dependent claims, both singly and multiply dependent, is herein expressly contemplated but is not described in detail for the sake of brevity. The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A rigid polyurethane foam comprising the reaction product of:
A. a resin composition comprising a novolac polyol that has a general chemical structure; 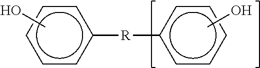
wherein R is an alkyl or alkylene group and said novolac polyol has an average hydroxyl functionality of from 2 to 30 calculated by dividing the weight average molecular weight of said novolac polyol by the equivalent weight of said novolac polyol; and
B. an isocyanate composition,
wherein said novolac polyol is present in an amount of from 3 to 65 parts by weight per 100 parts by weight of said resin composition.

2. A rigid polyurethane foam as set forth in claim 1 wherein said novolac polyol is present in an amount of from 5 to 60 parts by weight per 100 parts by weight of said resin composition.

3. A rigid polyurethane foam as set forth in claim 1 wherein said novolac polyol is present in an amount of from 20 to 60 parts by weight per 100 parts by weight of said resin composition.

4. A rigid polyurethane foam as set forth in claim 1 wherein said resin composition further comprises a second polyol.

5. A rigid polyurethane foam as set forth in claim 4 wherein said novolac polyol is present in an amount of at least 20 parts by weight per 100 parts by weight of said second polyol.

6. A rigid polyurethane foam as set forth in claim 4 wherein said second polyol is further defined as an aromatic polyester polyol having a hydroxyl number of from 200 to 350 mg KOH/g.

7. A rigid polyurethane foam as set forth in claim 1 wherein said resin composition and said isocyanate composition react at an isocyanate index of from about 105 to about 140.

8. A rigid polyurethane foam as set forth in claim 1 wherein said resin composition and said isocyanate composition react at an isocyanate index of from about 140 to about 300.

9. A rigid polyurethane foam as set forth in claim 7 wherein said resin composition further comprises a hydrofluorocarbon blowing agent.

10. A rigid polyurethane foam as set forth in claim 9 wherein said hydrofluorocarbon blowing agent is present in an amount of 5 to 15 parts by weight per 100 parts by weight of said resin composition.

11. A rigid polyurethane foam as set forth in claim 10 wherein said resin composition further comprises water present in an amount of from 1 to 3 parts by weight per 100 parts by weight of said resin composition.

12. A rigid polyurethane foam as set forth in claim 1 having a single-pass thickness of about 6 to about 9 inches without visible scorch.

13. A rigid polyurethane foam as set forth in claim 12 having an extinguish time of less than 11 seconds, a flame height of less than 25 cm, and a percent remaining of greater than 88 percent, as determined using ASTM 3014.

14. A rigid polyurethane foam as set forth in claim 7 wherein said resin composition further comprises a formic acid blowing agent.

15. A rigid polyurethane foam as set forth in claim 7 wherein said resin composition further comprises a hydrocarbon blowing agent.

16. A rigid polyurethane foam as set forth in claim 1 wherein R is further defined as —CH₂— and wherein said novolac polyol has an average hydroxyl functionality of from 3 to 5.

17. A rigid polyurethane foam as set forth in claim 1 wherein said novolac polyol is further defined as a reaction product of bisphenol A and formaldehyde.

18. A rigid polyurethane foam as set forth in claim 1 wherein said novolac polyol is further defined as a reaction product of phenol, cresol, and formaldehyde.

19. A rigid polyurethane foam as set forth in claim 1 wherein said novolac polyol is further defined as a reaction product of p-tert amylphenol and formaldehyde.

20. A rigid polyurethane foam as set forth in claim 1 wherein said novolac polyol is further defined as a reaction product of p-tert-butylphenol, phenol, and formaldehyde.

21. A rigid polyurethane foam as set forth in claim 1 wherein said novolac polyol is further defined as a reaction product of p-tert-butylphenol, bisphenol A, and formaldehyde.

22. A rigid polyurethane foam comprising the reaction product of:
A. a resin composition comprising;
(i) a novolac polyol that has a general chemical structure, 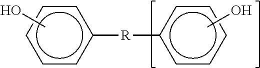
wherein R is an alkyl or alkylene group and said novolac polyol has an average hydroxyl functionality of from 3 to 30 calculated by dividing the weight average molecular weight of said novolac polyol by the equivalent weight of said novolac polyol,
(ii) an aromatic polyester polyol,
(iii) a hydrofluorocarbon blowing agent; and
B. an isocyanate composition,
wherein said novolac polyol is present in an amount of from 3 to 60 parts by weight per 100 parts by weight of said resin composition,
wherein said novolac polyol is present in an amount of at least 20 parts by weight per 100 parts by weight of said aromatic polyester polyol, and
wherein said rigid polyurethane foam has a thickness of about 6 to about 9 inches without visible scorch.

23. A rigid polyurethane foam as set forth in claim 22 wherein said resin composition and said isocyanate composition are reacted at an isocyanate index of from about 105 to about 140.

24. A rigid polyurethane foam as set forth in claim 22 wherein said resin composition and said isocyanate composition are reacted at an isocyanate index of from about 140 to about 300.

25. A rigid polyurethane foam as set forth in claim 22 wherein said resin composition further comprises water present in an amount of from 1 to 3 parts by weight per 100 parts by weight of said resin composition.

26. A rigid polyurethane foam as set forth in claim 22 having an extinguish time of less than 11 seconds, a flame height of less than 25 cm, and a percent remaining of greater than 88 percent, as determined using ASTM 3014.

27. A resin composition comprising:
A. a novolac polyol that has a general chemical structure; 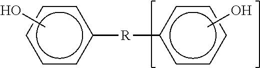
wherein R is an alkyl or alkylene group and said novolac polyol has an average hydroxyl functionality of from 3 to 30 calculated by dividing the weight average molecular weight of said novolac polyol by the equivalent weight of said novolac polyol;
B. an aromatic polyester polyol;
C. a hydrofluorocarbon blowing agent; and
D. water,
wherein said novolac polyol is present in an amount of from 5 to 60 parts by weight per 100 parts by weight of said resin composition, and
wherein said novolac polyol is present in an amount of at least 20 parts by weight per 100 parts by weight of said aromatic polyester polyol.

28. A method of forming rigid polyurethane foam on a surface wherein the rigid polyurethane foam comprises the reaction product of an isocyanate composition and a resin composition comprising a novolac polyol that has a general chemical structure; 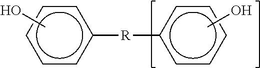
wherein R is an alkyl or alkylene group and said novolac polyol has an average hydroxyl functionality of from 2 to 30 calculated by dividing the weight average molecular weight of said novolac polyol by the equivalent weight of said novolac polyol and wherein said novolac polyol is present in an amount of from 3 to 65 parts by weight per 100 parts by weight of said resin composition, said method comprising the steps of:
A. providing the resin composition;
B. providing the isocyanate composition;
C. combining the resin composition and the isocyanate composition to form the rigid polyurethane foam on the surface.

29. A method as set forth in claim 28 wherein the resin composition and the isocyanate composition are combined at an isocyanate index of from about 130 to about 140.

30. A method as set forth in claim 29 wherein the step of combining is further defined as spraying the resin composition and the isocyanate composition in a single pass at a thickness of from about 6 to about 9 inches such that the rigid polyurethane foam has no visible scorch.

31. A method as set forth in claim 29 wherein the step of combining is further defined as spraying the resin composition and the isocyanate composition in a single pass at a thickness of from about 4 to about 6 inches such that the rigid polyurethane foam has no visible scorch.
